(19) United States
(12) Patent Application Publication
(10) Pub. No.: US 2026/0039621 A1
(43) Pub. Date: Feb. 5, 2026

(54) ADDRESS RESOLUTION PROTOCOL PROCESSING USED IN COMMUNICATIONS WITHIN A COMPUTING ENVIRONMENT

(71) Applicant: INTERNATIONAL BUSINESS MACHINES CORPORATION, Armonk, NY (US)

(72) Inventors: Bruce RATCLIFF, Red Hook, NY (US); Stephen R. VALLEY, Valatie, NY (US); Patricia G. DRIEVER, Poughkeepsie, NY (US); Jerry STEVENS, Raleigh, NC (US); Richard P. TARCZA, Kingston, NY (US)

(21) Appl. No.: 18/791,690

(22) Filed: Aug. 1, 2024

(51) Int. Cl. H04L 61/103

(52) U.S. Cl. CPC H04L 61/103

(57) ABSTRACT

A control program executing on a computing device of a computing environment transmits control request information to an adapter module executing within the computing environment. The transmitting uses a control plane transmit queue of a set of queues. The control plane transmit queue identifies a location to store the control request information to be retrieved by the adapter module. The control program receives from the adapter module an indication of another location storing control reply information replying to the control request information. The indication is obtained from a control plane receive queue of the set of queues. The control program retrieves from the another location the control reply information and performs processing based on the control reply information.

### BACKGROUND

One or more aspects relate, in general, to processing within a computing environment, and in particular, to address resolution protocol processing used in communications within the computing environment.

Communications between input/output (I/O) devices and one or more control programs executing within a computing environment are facilitated by a network interface card. The network interface card is shared by the control programs and facilitates the transfer of data, including large amounts of data, into or out of a control program and the control program's file system. It also facilitates the streaming of other types of large data, such as video or complex engineering or scientific graphics. Transferring large amounts of data, whether it be files, streams, or other data, can be very expensive in terms of central processing unit (CPU) cycles and the cost of the network input/output (I/O).

The network interface card uses media access control (MAC) addresses but other devices used in communications between the network interface card and the control programs may use different types of addresses, such as Internet Protocol (IP) addresses. Thus, the internet protocol addresses are to be mapped to the media access control addresses. The mapping is performed via an address resolution protocol (ARP). The address resolution protocol is, for instance, a layer 2 protocol to map addresses of one type to another type. For instance, the address resolution protocol maps media access control addresses to internet protocol addresses.

### SUMMARY

Shortcomings of the prior art are overcome, and additional advantages are provided through the provision of a computer-implemented method. The computer-implemented method includes transmitting, by a control program executing on a computing device of a computing environment to an adapter module executing within the computing environment, control request information. The transmitting uses a control plane transmit queue of a set of queues. The control plane transmit queue identifies a location to store the control request information to be retrieved by the adapter module. The control program receives from the adapter module an indication of another location storing control reply information replying to the control request information. The indication is obtained from a control plane receive queue of the set of queues. The control program retrieves from the another location the control reply information and performs processing based on the control reply information.

In one or more aspects, a computer-implemented method is provided. The computer-implemented method includes obtaining, by an adapter module executing within a computing environment from a control program executing on a computing device of the computing environment, an add address resolution protocol cache request for a selected address. An address resolution protocol request is sent to the selected address, and a reply to the address resolution protocol request is received. The reply is sent to the control program.

Computer-implemented methods, computer systems and computer program products relating to one or more aspects are described and claimed herein. Each of the embodiments of the computer-implemented method may be embodiments of each computer system and/or each computer program product and vice-versa. Further, each of the embodiments is separable and optional from one another. Moreover, embodiments may be combined with one another. Each of the embodiments of the computer-implemented method may be combinable with aspects and/or embodiments of each computer system and/or computer program product, and vice-versa. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to incorporate and use one or more aspects of the present disclosure;

FIG. 2A depicts one example of further details of the processing circuitry of FIG. 1, in accordance with one or more aspects of the present disclosure;

FIG. 2B depicts one example of further details of a processor of the processor set of FIG. 1, in accordance with one or more aspects of the present disclosure;

FIG. 3 depicts one example of a shared resource environment to incorporate and use one or more aspects of the present disclosure;

FIG. 4 depicts examples of queues to be used in communication within a computing environment, in accordance with one or more aspects of the present disclosure;

FIG. 5A depicts one example of an enhanced queued direct input/output (EQDIO) queue structure, in accordance with one or more aspects of the present disclosure;

FIG. 5B depicts one example of a format of a queue descriptor record, in accordance with one or more aspects of the present disclosure;

FIG. 5C depicts one example of a format of a queue descriptor of the queue descriptor record of FIG. 5B, in accordance with one or more aspects of the present disclosure;

FIG. 6 depicts one example of a control plane storage block page entry (SBPE), in accordance with one or more aspects of the present disclosure;

FIG. 7 depicts one example of a control plane control program queue index, in accordance with one or more aspects of the present disclosure;

FIG. 8 depicts one example of a control plane adapter queue index, in accordance with one or more aspects of the present disclosure;

FIG. 9 depicts one example of a format of an interrupt reduction control, in accordance with one or more aspects of the present disclosure;

FIG. 10 depicts one example of establish communication controls processing, in accordance with one or more aspects of the present disclosure;

FIG. 11 depicts one example of data constructs of a control plane queue structure used in accordance with one or more aspects of the present disclosure;

FIG. 12 depicts one example of control program communications processing, in accordance with one or more aspects of the present disclosure;

FIG. 13 depicts one example of adapter module communications processing, in accordance with one or more aspects of the present disclosure;

FIG. 14A depicts one example of address resolution protocol code of FIG. 1, in accordance with one or more aspects of the present disclosure;

FIG. 14B depicts one example of address resolution protocol offload code of the address resolution protocol code of FIG. 14A, in accordance with one or more aspects of the present disclosure;

FIG. 14C depicts one example of address resolution protocol filtering code of the address resolution protocol code of FIG. 14A, in accordance with one or more aspects of the present disclosure;

FIG. 15 depicts one example of address resolution protocol offload processing, in accordance with one or more aspects of the present disclosure;

FIG. 16 depicts one example of an Enable Address Resolution Protocol (ARP) Offload Request, in accordance with one or more aspects of the present disclosure;

FIG. 17 depicts one example of an Enable ARP Offload Reply, in accordance with one or more aspects of the present disclosure;

FIG. 18 depicts one example of an Unenable ARP Offload Request, in accordance with one or more aspects of the present disclosure;

FIG. 19 depicts one example of an Unenable ARP Offload Reply, in accordance with one or more aspects of the present disclosure;

FIG. 20 depicts one example of an ARP SetIP Request, in accordance with one or more aspects of the present disclosure;

FIG. 21 depicts one example of an ARP SetIP Reply, in accordance with one or more aspects of the present disclosure;

FIG. 22 depicts one example of an Add ARP Cache Request, in accordance with one or more aspects of the present disclosure;

FIG. 23 depicts one example of an Add ARP Cache Reply, in accordance with one or more aspects of the present disclosure;

FIG. 24 depicts one example of an Update ARP Cache Request, in accordance with one or more aspects of the present disclosure;

FIG. 25 depicts one example of an Update ARP Cache Reply, in accordance with one or more aspects of the present disclosure;

FIG. 26 depicts one example of an ARP Delete IP (DELIP) Request, in accordance with one or more aspects of the present disclosure;

FIG. 27 depicts one example of an ARP Delete IP Reply, in accordance with one or more aspects of the present disclosure;

FIG. 28 depicts one example of ARP Filter processing, in accordance with one or more aspects of the present disclosure;

FIG. 29 depicts one example of an Add ARP Filter Request, in accordance with one or more aspects of the present disclosure;

FIG. 30 depicts one example of an Add ARP Filter Reply, in accordance with one or more aspects of the present disclosure;

FIG. 31 depicts one example of a Remove ARP Filter Request, in accordance with one or more aspects of the present disclosure;

FIG. 32 depicts one example of a Remove ARP Filter Reply, in accordance with one or more aspects of the present disclosure; and

FIGS. 33A-33B depict another example of a computing environment to incorporate and use one or more aspects of the present disclosure.

### DETAILED DESCRIPTION

In accordance with one or more aspects of the present disclosure, a capability is provided to facilitate processing within a computing environment. For instance, communications between at least one control program (CP) executing on a computing device and a network interface card (NIC) coupled thereto are facilitated and improved. As examples, the control program is an operating system, a host, other types of control programs, etc.; and the network interface card may be referred to as a network interface controller.

In one or more aspects, communications within the computing environment include transmitting and receiving packets between, for instance, the control programs and the network interface card. To send a packet from a control program to a network interface card, an address, such as an internet protocol (IP) address, is used. However, the network interface card uses media access control (MAC) addresses. Therefore, an address resolution protocol (ARP) is used to determine the IP address that corresponds to the MAC address.

In one or more aspects, the address resolution protocol is improved, and therefore, communications, by using an enhanced queued direct input/output (EQDIO) facility that includes, for instance, queues, data buffers and an adapter module to facilitate address resolution protocol processing. The adapter module is coupled to the control programs and the network interface card and uses controls to facilitate communication.

In one or more aspects, control plane queues are used to transmit address resolution protocol requests from a control program to the adapter module and replies from the adapter module to the control program, as examples. These requests/replies enable the control program to obtain requested addresses.

In one or more aspects, address resolution protocol (ARP) offload and filtering are provided that use control plane (network router architecture) primitives so that each individual control program builds and maintains its own ARP cache (e.g., stored in control program memory). Traffic is transferred between control programs without having to route to the LAN, in one example. In one or more aspects, a dedicated queue pair assigned to each interface is used to exchange control information (e.g., control request/reply information, such as requests/replies; also referred to as primitives) between the control program and the adapter module. As an example, an Add_ARP_Cache primitive is used by the control program to generate an ARP Request for a remote address (e.g., an IPV4 or IPV6 Address). If a reply is received from the remote address, the reply is returned to the control program.

In one example, the control program transfers ARP ownership of an IP address to the adapter module using, for instance, an ARP_SETIP primitive. The adapter module informs the control program of an ARP request from a remote IP address which had an address matching one previously transferred by the control program to the adapter module.

In one or more aspects, an Add_ARP_Filter primitive is used to filter ARP request/replies and IPV6 neighbor solicitation and neighbor advertisements. In one example, the ARP filter function allows ARP packets to flow on the data plane. In one example, only the ARP packets matching the filter criteria pass through.

In one or more aspects, a computer-implemented method is provided. The computer-implemented method includes transmitting, by a control program executing on a computing device of a computing environment to an adapter module executing within the computing environment, control request information. The transmitting uses a control plane transmit queue of a set of queues. The control plane transmit queue identifies a location to store the control request information to be retrieved by the adapter module. The control program receives from the adapter module an indication of another location storing control reply information replying to the control request information. The indication is obtained from a control plane receive queue of the set of queues. The control program retrieves from the another location the control reply information and performs processing based on the control reply information. Use of the queues and adapter module in transmitting control request information and receiving control reply information facilitates communications processing within the computing environment and improves system performance. Having the ARP processing at the control plane removes the ARP flows from the higher performance data plane. This reduces the effects on performance on the data plane which can be caused by excessive ARP and Neighbor Discovery traffic. The ARP offload design handles unsolicited ARP flows which update or remove ARP cache entries. The design only forwards the requests and replies associated with the specified IP Subnet and filters the following, if unrelated to the defined subnet, in one example: Gratuitous (GRAT) ARP Requests; GRAT ARP Replies; NULL GRAT ARP Requests which are used to purge ARP cache entries associated with a specific address (e.g., MAC address); and/or ARP Requests containing a source protocol address and a null source hardware address which are used to remove an IP address from an ARP cache.

Additionally, or alternatively, in one example, the control request information includes an address resolution protocol (ARP) request. Use of the queues and adapter module facilitates ARP processing, improving communications processing within the computing environment and improving system performance.

Additionally, or alternatively, in one example, the address resolution protocol request is an address resolution protocol offload request. Use of the queues and adapter module facilitates ARP offload processing, improving communications processing within the computing environment and improving system performance. The control program can designate, for instance, the IP Subnet associated with the IP interface over which ARP offload is to be applied.

Additionally, or alternatively, in one example, the address resolution protocol offload request is one address resolution protocol offload request selected from a plurality of address resolution protocol offload requests including an enable offload request to enable address resolution protocol offload processing, a set request to register an address for address resolution protocol offload processing, and an add cache request to request address resolution protocol processing for an address. Using the requests in address resolution protocol processing facilitates informing the adapter module of processing that is to be performed for the address resolution protocol.

Additionally, or alternatively, in one example, the address resolution protocol request is an address resolution protocol filter request to be used to filter address resolution protocol requests. Use of the queues and adapter module facilitates ARP filtering processing, improving communications processing within the computing environment and improving system performance. The control program can designate, for instance, the IP Subnet associated with the IP interface over which ARP filtering is to be applied. The ARP filtering function enables a control program to retain the ARP functionality without, e.g., any IP updates and eliminates the ARP packets not associated with the IP address(es) associated with the IP interface.

Additionally, or alternatively, in one example, transmitting the control request information includes updating a control block to indicate the location in which the control request information is stored. This facilitates access to the request, improves system performance and reduces latency.

Additionally, or alternatively, in one example, the transmitting the control request information includes giving initiative to the adapter module to process the control request information. Use of the adapter module in processing control request information facilitates communications processing within the computing environment and improving system performance.

Additionally, or alternatively, in one example, the receiving the indication of the another location storing the control reply information includes accessing a control block of the control plane receive queue to obtain the another location. This facilitates access to the reply, improving system performance and reducing latency.

Additionally, or alternatively, in one example, the control request information includes an address of one type and the control reply information includes another address of another type. The other address of the other type corresponding to the address of the one type. This facilitates translating one address to another, which facilitates communication within the computing environment.

Additionally, or alternatively, in one example, the control program adds the another address to an address resolution protocol cache of the control program. Use of the cache facilitates access to the address and improves system performance. This enables the control program to maintain an existing ARP cache without having to continuously query the ARP offload module for updates to the ARP cache.

In accordance with one or more aspects, each of the embodiments is separable and optional from one another. Further, embodiments may be combined with one another.

In one or more aspects, a computer system is provided. The computer system includes at least one computing device, a set of one or more computer-readable storage media, and program instructions, collectively stored in the set of one or more computer-readable storage media, for causing the at least one computing device to perform computer operations. The computer operations include transmitting, by a control program executing on a computing device of a computing environment to an adapter module executing within the computing environment, control request information. The transmitting uses a control plane transmit queue of a set of queues. The control plane transmit queue identifies a location to store the control request information to be retrieved by the adapter module. The control program receives from the adapter module an indication of another location storing control reply information replying to the control request information. The indication is obtained from a control plane receive queue of the set of queues. The control program retrieves from the another location the control reply information and performs processing based on the control reply information. Use of the queues and adapter module in transmitting control request information and receiving control reply information facilitates communications processing within the computing environment and improves system performance. Having the ARP processing at the control plane removes the ARP flows from the higher performance data plane. This reduces the effects on performance on the data plane which can be caused by excessive ARP and Neighbor Discovery traffic. The ARP offload design handles unsolicited ARP flows which update or remove ARP cache entries. The design only forwards the requests and replies associated with the specified IP Subnet and filters the following, if unrelated to the defined subnet, in one example: GRAT ARP Requests; GRAT ARP Replies; NULL GRAT ARP Requests which are used to purge ARP cache entries associated with a specific address (e.g., MAC address); and/or ARP Requests containing a source protocol address and a null source hardware address which are used to remove an IP address from an ARP cache.

Additionally, or alternatively, in one example, the control request information includes an address resolution protocol offload request. The address resolution protocol offload request is one address resolution protocol offload request selected from a plurality of address resolution protocol offload requests including an enable offload request to enable address resolution protocol offload processing, a set request to register an address for address resolution protocol offload processing, and an add cache request to request address resolution protocol processing for an address. Using the requests in address resolution protocol processing facilitates informing the adapter module of processing that is to be performed for the address resolution protocol. Use of the queues and adapter module facilitates ARP offload processing, improving communications processing within the computing environment and improving system performance. The control program can designate, for instance, the IP Subnet associated with the IP interface over which ARP offload is to be applied.

Additionally, or alternatively, in one example, the control request information includes an address resolution protocol filter request to be used to filter address resolution protocol requests. Use of the queues and adapter module facilitates ARP filtering processing, improving communications processing within the computing environment and improving system performance. The control program can designate, for instance, the IP Subnet associated with the IP interface over which ARP filtering is to be applied. The ARP filtering function enables a control program to retain the ARP functionality without, e.g., any IP updates and eliminates the ARP packets not associated with the IP address(es) associated with the IP interface.

Additionally, or alternatively, in one example, transmitting the control request information includes updating a control block to indicate the location in which the control request information is stored. This facilitates access to the request, improves system performance and reduces latency.

Additionally, or alternatively, in one example, the receiving the indication of the another location storing the control reply information includes accessing a control block of the control plane receive queue to obtain the another location. This facilitates access to the reply, improving system performance and reducing latency.

In accordance with one or more aspects, each of the embodiments is separable and optional from one another. Further, embodiments may be combined with one another.

In one or more aspects, a computer program product is provided. The computer program product includes a set of one or more computer-readable storage media and program instructions, collectively stored in the set of one or more computer-readable storage media, for causing at least one computing device to perform computer operations. The computer operations include transmitting, by a control program executing on a computing device of a computing environment to an adapter module executing within the computing environment, control request information. The transmitting uses a control plane transmit queue of a set of queues. The control plane transmit queue identifies a location to store the control request information to be retrieved by the adapter module. The control program receives from the adapter module an indication of another location storing control reply information replying to the control request information. The indication is obtained from a control plane receive queue of the set of queues. The control program retrieves from the another location the control reply information and performs processing based on the control reply information. Use of the queues and adapter module in transmitting control request information and receiving control reply information facilitates communications processing within the computing environment and improves system performance. Having the ARP processing at the control plane removes the ARP flows from the higher performance data plane. This reduces the effects on performance on the data plane which can be caused by excessive ARP and Neighbor Discovery traffic. The ARP offload design handles unsolicited ARP flows which update or remove ARP cache entries. The design only forwards the requests and replies associated with the specified IP Subnet and filters the following, if unrelated to the defined subnet, in one example: GRAT ARP Requests; GRAT ARP Replies; NULL GRAT ARP Requests which are used to purge ARP cache entries associated with a specific address (e.g., MAC address); and/or ARP Requests containing a source protocol address and a null source hardware address which are used to remove an IP address from an ARP cache.

Additionally, or alternatively, in one example, the control request information includes an address resolution protocol (ARP) request. Use of the queues and adapter module facilitates ARP processing, improving communications processing within the computing environment and improving system performance.

Additionally, or alternatively, in one example, the control request information includes an address resolution protocol offload request. The address resolution protocol offload request is one address resolution protocol offload request selected from a plurality of address resolution protocol offload requests including an enable offload request to enable address resolution protocol offload processing, a set request to register an address for address resolution protocol offload processing, and an add cache request to request address resolution protocol processing for an address. Using the requests in address resolution protocol processing facilitates informing the adapter module of processing that is to be performed for the address resolution protocol. Use of the queues and adapter module facilitates ARP offload processing, improving communications processing within the computing environment and improving system performance. The control program can designate, for instance, the IP Subnet associated with the IP interface over which ARP offload is to be applied.

Additionally, or alternatively, in one example, the control request information includes an address resolution protocol filter request to be used to filter address resolution protocol requests. Use of the queues and adapter module facilitates ARP filtering processing, improving communications processing within the computing environment and improving system performance. The control program can designate, for instance, the IP Subnet associated with the IP interface over which ARP filtering is to be applied. The ARP filtering function enables a control program to retain the ARP functionality without, e.g., any IP updates and eliminates the ARP packets not associated with the IP address(es) associated with the IP interface.

Additionally, or alternatively, in one example, transmitting the control request information includes updating a control block to indicate the location in which the control request information is stored. This facilitates access to the request, improves system performance and reduces latency.

Additionally, or alternatively, in one example, the receiving the indication of the another location storing the control reply information includes accessing a control block of the control plane receive queue to obtain the another location. This facilitates access to the reply, improving system performance and reducing latency.

In accordance with one or more aspects, each of the embodiments is separable and optional from one another. Further, embodiments may be combined with one another.

In one or more aspects, a computer-implemented method is provided. The computer-implemented method includes obtaining, by an adapter module executing within a computing environment from a control program executing on a computing device of the computing environment, an add address resolution protocol cache request for a selected address. An address resolution protocol request is sent to the selected address. A reply to the address resolution protocol request is received, and the reply is sent to the control program. Use of the adapter module facilitates ARP processing, improving communications processing within the computing environment and improving system performance.

Additionally, or alternatively, in one example, the reply includes another address corresponding to the selected address. This improves communications within the computing environment.

In accordance with one or more aspects, each of the embodiments is separable and optional from one another. Further, embodiments may be combined with one another.

In one or more aspects, a computer program product is provided. The computer program product includes a set of one or more computer-readable storage media, and program instructions, collectively stored in the set of one or more computer-readable storage media, for causing at least one computing device to perform computer operations. The computer operations include obtaining, by an adapter module executing within a computing environment from a control program executing on a computing device of the computing environment, an add address resolution protocol cache request for a selected address. An address resolution protocol request is sent to the selected address. A reply to the address resolution protocol request is received, and the reply is sent to the control program. Use of the adapter module facilitates ARP processing, improving communications processing within the computing environment and improving system performance.

Additionally, or alternatively, in one example, the reply includes another address corresponding to the selected address. This improves communications within the computing environment.

In accordance with one or more aspects, each of the embodiments is separable and optional from one another. Further, embodiments may be combined with one another.

Computer-implemented methods, computer systems and computer program products relating to one or more aspects are described and claimed herein. Each of the embodiments of the computer program product may be embodiments of each computer system and/or each computer-implemented method and vice-versa. Further, each of the embodiments is separable and optional from one another. Moreover, embodiments may be combined with one another. Each of the embodiments of the computer program product may be combinable with aspects and/or embodiments of each computer system and/or computer-implemented method, and vice-versa.

One or more aspects of the present disclosure are incorporated in, performed and/or used by a computing environment. As examples, the computing environment may be of various architectures and of various types, including, but not limited to: personal computing, client-server, distributed, virtual, emulated, partitioned, non-partitioned, cloud-based, quantum, grid, time-sharing, cluster, peer-to-peer, wearable, mobile, having one node or multiple nodes, having one processor or multiple processors, and/or any other type of environment and/or configuration, etc. that is capable of executing a process (or multiple processes) that performs address resolution protocol processing, enhanced queued direct input/output (EQDIO) processing and/or one or more other aspects of the present disclosure. Aspects of the present disclosure are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

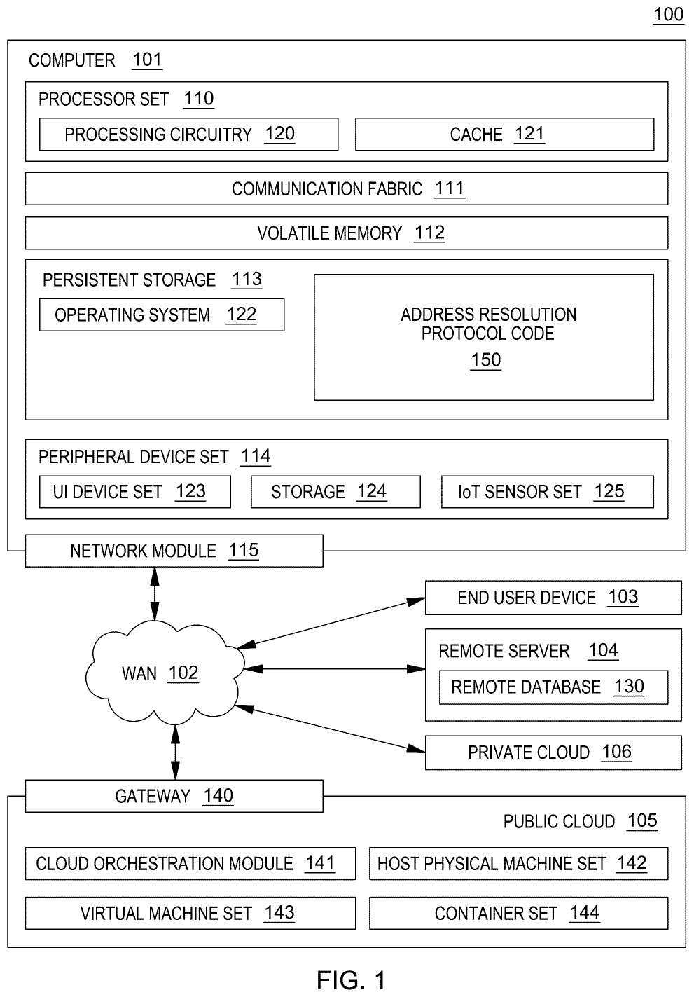

One example of a computing environment to perform, incorporate and/or use one or more aspects of the present disclosure is described with reference to FIG. 1. In one example, a computing environment 100 contains an example of an environment for the execution of at least some of the computer code involved in performing the inventive methods, such as address resolution protocol code 150 (also referred to herein as block 150). In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud computing services and/or microservices (not separately shown in FIG. 1): private and public clouds 106, 105 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The computing environment described above is only one example of a computing environment to incorporate, perform and/or use one or more aspects of the present disclosure. Other examples are possible. For instance, in one or more embodiments, one or more of the components/modules/blocks of FIG. 1 are not included in the computing environment and/or are not used for one or more aspects of the present disclosure. Further, in one or more embodiments, additional and/or other components/modules/blocks may be used. Other variations are possible.

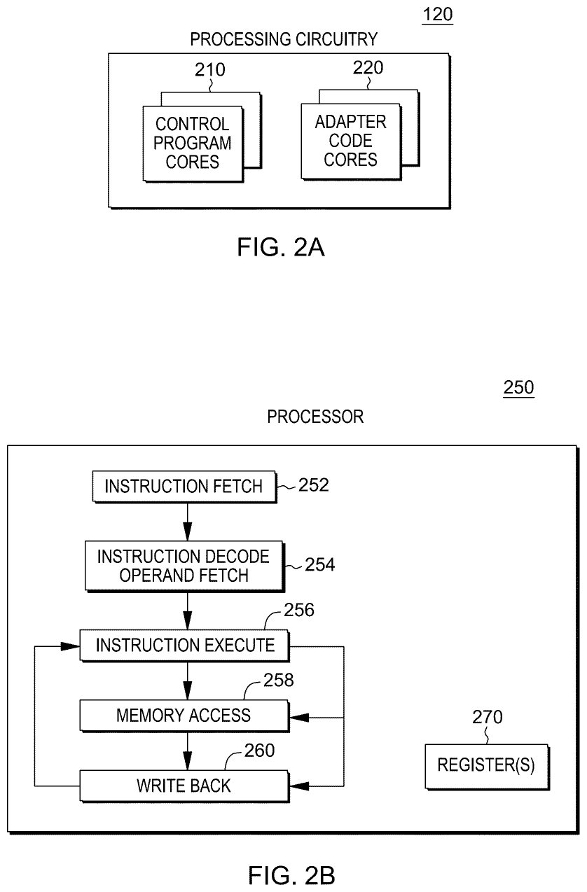

In one example, processing circuitry 120 of processor set 110 includes a plurality of processor cores. For instance, as depicted in FIG. 2A, processing circuitry 120 includes one or more control program cores 210 to execute control program code and one or more adapter code cores 220 to execute adapter code of, e.g., an adapter module used in accordance with one or more aspects of the present disclosure. Control program cores 210 and adapter code cores 220 are cores of one or more processors of processor set 110. As examples, control program cores 210 and adapter code cores 220 may be cores of a same processor or cores of separate processors. Many examples are possible. In one example, one or more control program cores and one or more adapter code cores execute at least portions of address resolution protocol code 150.

In one example, a processor (e.g., of processor set 110) includes a plurality of functional components (or a subset thereof) used to, for instance, execute instructions. As depicted in FIG. 2B, in one example, a processor 250 includes, for instance, an instruction fetch component 252 to fetch instructions to be executed; an instruction decode/operand fetch component 254 to decode the fetched instructions and to obtain operands of the decoded instructions; one or more instruction execute components 256 to execute the decoded instructions; a memory access component 258 to access memory for instruction execution, if necessary; and a write back component 260 to provide the results of the executed instructions. One or more of the components may access and/or use one or more registers 270 in instruction processing. Further, one or more of the components may access and/or use address resolution protocol code 150. Additional, fewer and/or other components may be used in one or more aspects of the present disclosure.

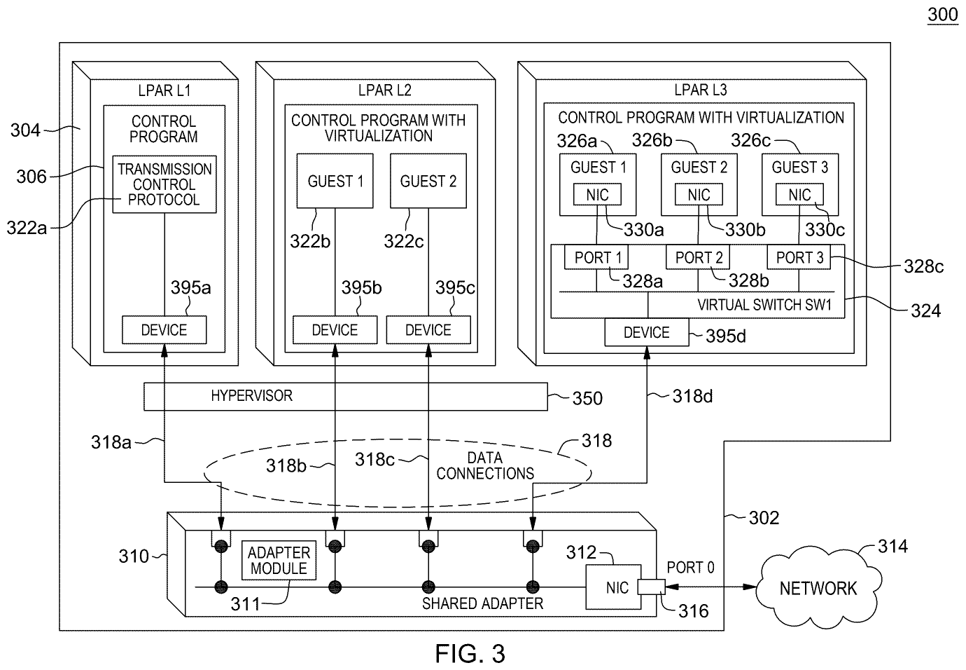

Further details of a computing environment to incorporate and use one or more aspects of the present disclosure are described with reference to FIG. 3. In one example, the computing environment is a shared resource environment 300, aspects of which are based, for instance, on the z/Architecture® instruction set architecture offered by International Business Machines Corporation, Armonk, New York. One embodiment of the z/Architecture instruction set architecture is described in a publication entitled, “z/Architecture Principles of Operation,” IBM Publication No. SA22-7832-13, Fourteenth Edition, May 2022, which is hereby incorporated herein by reference in its entirety. The z/Architecture instruction set architecture, however, is only one example architecture; other architectures and/or other types of computing environments of International Business Machines Corporation and/or of other entities/companies may include and/or use one or more aspects of the present disclosure. z/Architecture and IBM are trademarks or registered trademarks of International Business Machines Corporation in at least one jurisdiction.

In one example, shared resource environment 300 includes a central processor complex (CPC) 302, having, for instance, one or more partitions or zones 304 (e.g., logical partitions (e.g., LPAR L1-LPAR L3)). Each logical partition may have a resident control program 306, which may differ for one or more of the logical partitions. That is, control program 306 may be different types of control programs. Although in this example, three logical partitions are described, other embodiments can include more or fewer logical partitions. Further, one or more of the partitions may not be executing a control program, and/or may execute control programs other than those described herein. Moreover, one logical partition can have multiple control programs. Other examples are possible.

One or more of the logical partitions are managed by a hypervisor 350, which enables the hardware to virtualize the logical partitions.

Each logical partition is coupled, in one example, to a shared adapter 310 (also referred to as a shared network adapter). In one example, shared adapter 310 includes an adapter module 311 used in communications between a network interface card (NIC) 312 (e.g., network module 115) and one or more control programs 306. Shared adapter 310 is coupled to network interface card 312. As examples, in one embodiment, shared adapter 310 includes network interface card 312 or in another embodiment, shared adapter 310 is coupled to but separate from network interface card 312. Regardless of how shared adapter 310 is coupled to network interface card 312, adapter module 311 of shared adapter 310 is coupled to network interface card 312 and facilitates communication between network interface card 312 and one or more control programs 306, in accordance with one or more aspects of the present disclosure.

In one example, network interface card 312 enables communication between an external network 314 (and/or one or more input/output devices) and one or more control programs 306. In one example, network interface card 312 is coupled to external network 314 via, e.g., a port 316. External network 314 may be used to communicate between the logical partitions of shared resource environment 300 or with computing devices of other computing environments over, e.g., a local area network (LAN), a wide area network (WAN), or any other possible networks, such as Ethernet or fibre channels, as examples.

Adapter module 311 includes, for instance, adapter code used in communications between the control programs (e.g., control programs 306) in the logical partitions (e.g., logical partitions 304) and network interface card 312. For instance, adapter module 311 provides an interface to communicate between the logical partitions and other components (e.g., network interface card 312) of shared adapter 310. In one example, the adapter code is stored in memory owned by the adapter module or the shared adapter and is executed by one or more computing devices of the central processor complex (e.g., one or more adapter code cores (e.g., adapter code cores 220) of one or more processors). As examples, the adapter code may be software code, microcode, firmware, and/or other code. Firmware includes, e.g., the microcode or milli-code of a processor. It includes, for instance, the hardware-level instructions and/or data structures used in implementation of higher-level machine code. In one embodiment, it includes, for instance, proprietary code that is typically delivered as microcode or milli-code that includes trusted software, microcode or milli-code specific to the underlying hardware and controls operating system access to the system hardware. In one example, adapter module 311 includes code, hardware and/or firmware. Various examples are possible.

In one example, the logical partitions have devices 395a-395d (also referred to as a device 395 or devices 395), which serve as interfaces between a respective control program in the logical partitions and shared adapter 310. While FIG. 3 depicts each logical partition as having one device 395, a logical partition (or a control program in the logical partition) may have multiple devices 395 (e.g., one device 395 dedicated to IPv4 (internet protocol version 4) traffic and another device 395 dedicated to IPv6 (internet protocol version 6) traffic). Other examples are possible.

Shared adapter 310 includes, in one example, a plurality of data connections 318, each of which is coupled to one of devices 395 within a logical partition. For instance, a data connection 318a is coupled to a device 395a in logical partition 1; data connections 318b, 318c are coupled to devices 395b, 395c, respectively, in logical partition 2; and a data connection 318d is coupled to a device 395d in logical partition 3. In one example, data connections 318 are enhanced queued direct I/O (EQDIO) data connections. Further, data connections 318 can be used to transmit both data for user applications, as well as control data.

Device 395a is further coupled to an entity 322a, such as a Transmission Control Protocol/Internet Protocol (TCP/IP) stack, a protocol stack for a selected control program in logical partition 1; devices 395b, 395c are further coupled to entities 322b, 322c (such as Guest 1, Guest 2), respectively, in logical partition 2; and device 395d is further coupled to a virtual switch 324 in logical partition 3. Other examples and/or variations are possible.

Virtual switch 324 enables further sharing of data among entities 326a, 326b and 326c (e.g., Guest 1, 2 and 3) of logical partition 3. Virtual switch 324 includes a plurality of ports 328a, 328b and 328c, each of which is coupled to a respective guest via, e.g., a network internet card (NIC) 330a, 330b, and 330c, respectively. The virtual switch allows the guests coupled thereto to communicate with one another without using the adapter or the external network.

FIG. 3 is only one example of a computing environment to incorporate and use one or more aspects of the present disclosure. Although aspects are applied to a computing environment where multiple entities (e.g., logical partitions (LPARs) or virtual machines (VM)) share a common network interface card, other examples are possible. One or more aspects may be applied to any computing environment in which a shared resource, such as a shared network interface card or shared adapter, is used. Further, one or more aspects may be applied to any computing environment that uses an address resolution protocol. In one example, aspects of the present disclosure may be applied to any suitable hardware system and control program(s). Other examples are possible.

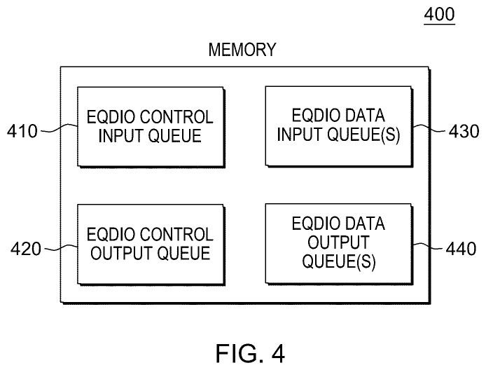

In accordance with one or more aspects, a computing environment, such as computing environment 100 and/or shared resource computing environment 300, uses an enhanced queued direct input/output (I/O) (EQDIO) facility for communicating between, for instance, computing devices (e.g., processors, etc.) and a network interface card (e.g., an Open Systems Adapter (OSA) or other network interface card). In one example, when the enhanced queued direct I/O (EQDIO) facility is provided by a computing environment (e.g., computing environment 300), a plurality of queues is configured for use in communications. For example, referring to FIG. 4, a plurality of queues is stored in memory 400 (e.g., main memory, also referred to as main storage) and includes one control input queue (e.g., EQDIO control input queue) 410 and one control output queue (e.g., EQDIO control output queue) 420 to be used for control plane operations for each EQDIO subchannel, and one or more data input queues (e.g., EQDIO data input queues) 430 and one or more data output queues (e.g., EQDIO data output queues) 440 to be used for data operations. A subchannel represents an input/output device and is used to pass I/O requests to a channel subsystem used to move data.

In one example, a minimum of 0 and a maximum of 30 data input queues (e.g., EQDO data input queues) 430 and a minimum of 0 and a maximum of 30 data output queues (e.g., EQDIO data output queues) 440 are to be provided for data plane operations. The total number of a combination of EQDIO control input queue, EQDIO control output queue, EQDIO data input queues and EQDIO data output queues is not to exceed 32, in one example. When using an EQDIO subchannel to support, for instance, a network trace analyzer function, in addition to the control queues there is to be at least 1 input data queue defined. Other examples are possible.

When EQDIO control and data input queues are provided, the program (e.g., control program) can directly access data placed into the input queues by the shared adapter (e.g., shared adapter 310). Typically, the source of the data placed into data input queues is an I/O device or a network of devices to which the network interface card of the shared adapter is connected. The source of the data placed into the control input queue is the adapter module, in one example. Correspondingly, when EQDIO control and data output queues are provided, the program (e.g., control program) transmits data directly to the shared adapter by placing data into the appropriate output queues; thereby saving resources and time. Depending on the shared adapter, the data placed into data output queues may be used internally by the shared adapter or may be transmitted to one or more I/O devices to which the shared adapter is connected. The data placed into the control output queue is used internally by the shared adapter (e.g., by the adapter module). For EQDIO queues, in one example, main storage is used as the medium by which data is exchanged between the program (e.g., control program) and the shared adapter. Additionally, these queues provide the ability for both the program (e.g., control program) and the shared adapter to directly communicate with each other in an asynchronous manner that is both predictable and efficient without requiring the services of a centralized controlling mechanism, such as a control program input/output supervisor, and the resulting overhead such a control mechanism implies.

In one example, both control input and output queues 410, 420, respectively, and data input and output queues 430, 440, respectively, are constructed in memory 400 (e.g., main memory) by a control program and are initialized and activated at an adapter module, as described herein. Each queue has a queue structure including, for instance, multiple separate queue components (also referred to as data constructs) that collectively describe the queue's characteristics and provide controls to allow the exchange of data between the control program and the adapter module.

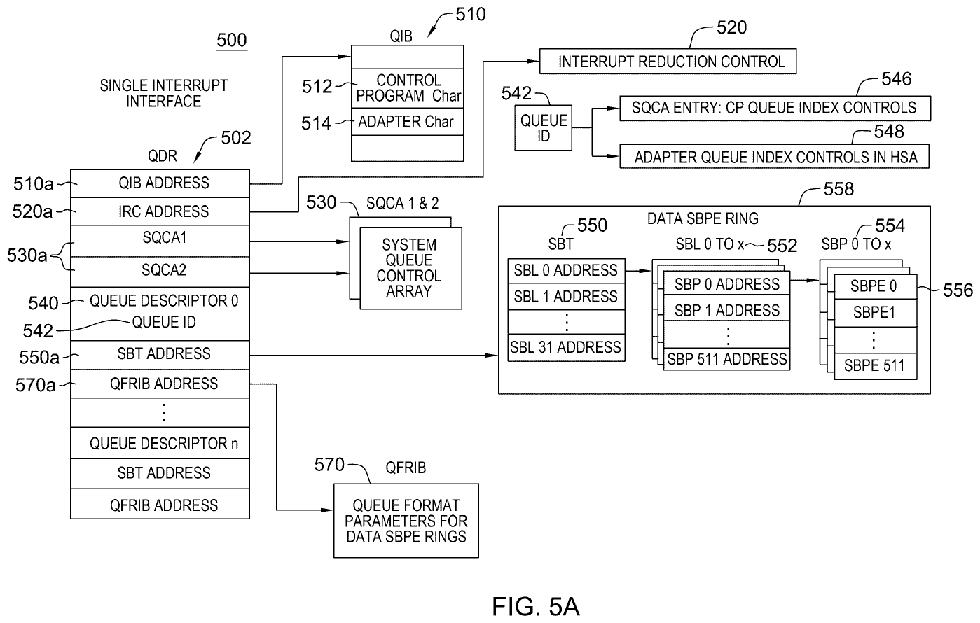

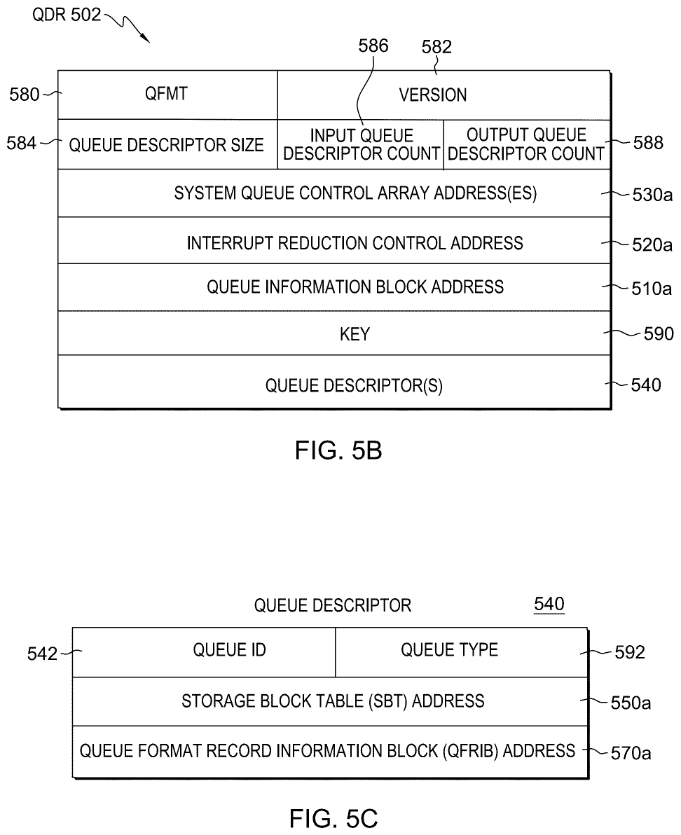

One example of an EQDIO queue structure is described with reference to FIG. 5A. As an example, an EQDIO queue structure 500 includes:
Queue Descriptor Record (QDR) 502: In one example, one queue descriptor record is defined per EQDIO subchannel. The queue descriptor record provides information about the collection of input and output queues associated with the subchannel along with anchor pointers to other structures relevant for queue management and operations. In one example, queue descriptor record 502 includes, for instance:
   Queue Information Block (QIB) Address 510a: In one example, queue information block address 510a identifies a queue information block 510. In one example, one queue information block 510 is defined per enhanced queued direct I/O subchannel. The queue information block is a control area used to exchange characteristics between the control program and the adapter module. It provides, for instance, information about control program characteristics 512 and adapter characteristics 514 (e.g., network interface card characteristics) associated with the subchannel. An address 510a of the queue information block is passed in queue descriptor record (QDR) 502 to the system by, for instance, execution of an Establish-QDIO-Queues Channel Command Word (CCW) of a Start Subchannel instruction. Other mechanisms may be used.
   Interrupt Reduction Control (IRC) Address 520a: In one example, interrupt reduction control address 520a identifies an interrupt reduction control 520. In one example, there is one interrupt reduction control 520 defined for each EQDIO device (e.g., device 395a-d). Each output queue and input queue is mapped to one of the, e.g., 32 bits of an interrupt reduction control queue mask (of interrupt reduction control 520) based on a defined queue ID 542 in a queue descriptor 540 of queue descriptor record 502. The interrupt reduction control includes, for instance, an interrupt state which is used by the adapter module to indicate if an interrupt is to be performed when a queue mask update is made.
   System Queue Control Array (SQCA) Addresses (SQCA1, SQCA2) 530a: In one example, one or more system queue control array addresses 530a indicate one or more system queue control arrays 530 (SQCA1 & 2). As an example, a system queue control array 530 includes up to, e.g., two 4K-pages that are 4K page-aligned within control program memory. The first page includes, for instance, control program (CP) queue index controls 546 for queue IDs 0 to 15 while the second 4K-page contains, for instance, control program (CP) queue index controls 546 for queue IDs 16 to 31. Each page, when defined, is to allocate the entire 4K of memory, in one example. Since each enhanced QDIO subchannel is to have at least one input control queue and one output control queue, the first page is to be allocated. The second page is allocated, e.g., when there are more than 16 queues defined. System queue control array 530 is allocated by the control program and is passed in the queue descriptor record to the system in execution of, e.g. an Establish-QDIO-Queues Channel Command Word (CCW) of a Start Subchannel instruction. Subsequent to the successful execution of this command, the system queue control array is no longer to be accessed directly (read or written) by the control program, in one example.
   In one example, the system queue control array addresses, SQCA1 and SQCA2, are pointers to, e.g., 4K pages. Each 4K page contains an array of, e.g., 16 entries. Each system queue control array entry is, e.g., 256 bytes. There is one system queue control array entry allocated in the system queue control array for each defined EQDIO queue. During initialization, the adapter module maps the queue descriptor (described herein) in the queue descriptor record to the matching index in the system queue control array. Each system queue control array entry contains the control program queue index area associated with the specific queue type. For instance, if the queue descriptor defines the queue type as a receive control plane queue, the control program queue index area in the system queue control array has a receive control plane control program queue index (e.g., format shown in FIG. 7, described herein).
   Queue Descriptor (QD) 540 (may also be referred to as a queue descriptor array entry): In one example, one queue descriptor 540 is defined for each EQDIO input and output (control or data) queue for a given subchannel. Each queue descriptor 540 provides a queue identifier (ID) 542, as well as information about the EQDIO queue and the main storage addresses used to access the queue contents. The maximum number of queue descriptors is 32, in one example. The queue descriptors of the queues (e.g., all the queues) associated with a subchannel are contained in queue descriptor record 502. Each queue descriptor 540 includes, in one example:
      Queue Identifier (ID) 542: In one example, queue identifier 542 is used to indicate, for instance, a system queue control array entry for control program queue index controls 546 and an adapter (ADP) queue index controls 548 in, e.g., a hardware system area (HSA).
      Storage Block Table (SBT) Address 550a: In one example, storage block table address 550a indicates a storage block table 550. One storage block table 550 is defined for each EQDIO queue associated with a subchannel. The storage block table has a fixed length of, e.g., 256 bytes and contains a maximum of, e.g., 32 entries, one entry for each of the possible EQDIO storage block list (SBL) 552 associated with the queue.
      Storage Block List (SBL) 552: In one example, up to, e.g., 32 storage block lists are defined for each EQDIO queue associated with a subchannel. The storage block lists contain pointers to storage block pages (SBPs) 554 that contain, e.g., a contiguous allocation of storage block page entries (SBPEs) 556 associated with an EQDIO queue. A storage block list contains entries for up to, e.g., 512 storage block pages.
      Storage Block Page (SBP) 554: In one example, up to, e.g., 512 storage block pages are defined, each pointing to, e.g., a contiguous list of storage block page entries (SBPEs) 556 that provide information about the I/O buffer location, configuration and state in main storage. The length of the storage block pages associated with a particular queue is set by the control program. The number of storage block page entries contained in a storage block page is variable based on the page size, the associated length of the storage block page entries defined for this EQDIO queue, and the queue type, as examples.
      Storage Block Page Entry (SBPE) 556: In one example, there is one storage block page entry for each of the I/O buffers associated with an EQDIO queue. When the storage block page entry is an immediate data entry, there may be more than one entry chained together. Each entry provides addressing and state information about its associated I/O buffer. The size (length) of a storage block page entry can be variable based on the specific queue type. The queue types include, for example: control plane queue (Format 0); data plane input queue (Format 1); and data plane output queue (Format 0), as examples.
      In one example, the storage block tables 550, storage block lists 552 and storage block pages 554 are part of a data storage block page entry ring 558.
      Queue Format Record Information Block (QFRIB) Address 570a: In one example, queue format record information block address 570a indicates a queue format record information block 570. As an example, one queue format record information block 570 is defined for each queue. The queue format record information block provides specific configuration information about the queues. The address of the queue format record information block is passed in queue descriptor record 502 to the system in execution of the, e.g., Establish-QDIO-Queues Channel Command Word (CCW) of a Start Subchannel instruction.

A queue descriptor record, such as queue descriptor record 502, may include additional, fewer and/or other information. For example, as shown in FIG. 5B, in a further example, queue descriptor record 502 includes the following information, some of which is also described with reference to FIG. 5A:
Queue Format (QFMT) 580: In one example, byte 0 of word 0 of queue descriptor record 502 includes queue format 580 that enables the use of multiple protocols, each using a specific format for their storage block page entries, control program and adapter queue index areas, interrupt reduction control, etc. In one example, a value of 8 is for Open Systems Adapter (OSA) Hybrid (OSH) networking. Other examples are possible.
Version 582: In one example, byte 1 of word 0 of queue descriptor record 502 indicates the version of the queue descriptor record. It enables support for multiple versions of a specific queue format. For example, a version 2 might support an expanded format of the storage block page entries which is not supported in version 1. In one example, for Open Systems Adapter (OSA) Hybrid (OSH) networking queues this value is, e.g., 1. Other examples are possible.
Queue Descriptor Size 584: In one example, byte 1 of word 1 of queue descriptor record 502 includes the queue descriptor size. In one example, queue descriptor size 584 informs the adapter module (e.g., adapter module 311) of the size of queue descriptor 540. It includes, for instance, the total number of 4-byte words contained in a queue descriptor. The value is the same, in one example, for a given queue format value. In one example for EQDIO OSA Hybrid, this value is, e.g., 12 words in length. Other examples are possible.
Input Queue Descriptor Count 586: In one example, byte 1 of word 1 of queue descriptor record 502 is the number of input (receive) queue descriptors defined. The minimum is, for instance, 1 and the maximum is, for instance, 31. Other examples are possible.
As for input data queues, the device may include multiple receive (input) data queues which may be assigned different priorities. (As used herein, receive and input with respect to the queues and/or data constructs of the queues are used interchangeably unless specified or understood otherwise.) The control program may process the received packets differently depending on which receive queue they are in. One other use for multiple receive queues is that the control program can configure a specific receive queue for a special traffic type (e.g., address resolution protocol (ARP)), therefore enabling the control program to attach a special program specifically designed for that traffic type. Other examples are possible.
Output Queue Descriptor Count 588: In one example, byte 3 of word 1 of queue descriptor record 502 includes the number of output (transmit) queue descriptors defined. The minimum is, for instance, 1 and the maximum is, for instance, 31. Other examples are possible.
As for output data queues, the device may include multiple transmit (output) queues where each queue can have a different priority. (As used herein, transmit and output with respect to the queues and/or data constructs of the queues are used interchangeably unless specified or understood otherwise.) For example, for each pass, the adapter module may process at most, e.g., 5 packets for one transmit queue (even if it has more packets than that) but may process up to, e.g., 10 packets for another, higher priority, transmit queue in the device. Other examples are possible.
System Queue Control Array (SQCA) Address(es) 530a: In one example, bytes 0-3 of words 2 and 3 of queue descriptor record 502 include a system queue control array address 1 (e.g., system queue control array address 1 (530a)) that includes the, e.g., 64-bit absolute address of, e.g., a 4K page that is to be on, e.g., a 4K boundary within control program memory that includes the system queue control array (e.g., system queue control array 1 (530)) containing the control program queue index controls for the first, e.g., 16 queue IDs (e.g., queues 0 to 15). The input and output control planes are to be defined and thus, the system queue control array 1 is to be defined.
Further, in one example bytes 0 to 3 of words 4 and 5 include a system queue control array address 2 (e.g., system queue control array address 2 (530a)) that includes the, e.g., 64-bit absolute address of, e.g., a 4K page that is to be on, e.g., a 4K boundary within control program memory that includes the system queue control array (e.g., system queue control array 2 (530)) containing the control program queue index controls for the second set of, e.g., 16 queue IDs (e.g., queues 16 to 31), if defined. If none of these queue IDs are defined, then this memory does not need to be allocated and this address is set to, e.g., zero.
In one example, system queue control array address(es) 530a includes the address(es) for control program queue index controls 546 in control program memory. For instance, system queue control array address 530a includes the memory address of the control program queue index controls so that the adapter module can read the index to determine, for instance, which of the transmit storage block page entries in control program memory correspond to new transmit packets. In one embodiment, each transmit queue in the device has its own set of transmit storage block page entries. As such, each transmit queue can also have its own control program queue index controls.
In one example, each system queue control array includes one or more entries (e.g., each being a 256-byte entry on, e.g., a 256-byte boundary) for one or more queues, and each entry includes, for instance, control program queue index controls (e.g., control program queue index controls 546).
Interrupt Reduction Control Address 520a: In one example, bytes 0 to 3 of words 6 and 7 of queue descriptor record 502 include the, e.g., 64-bit absolute address of an interrupt reduction control (e.g., interrupt reduction control 520). It is, for instance, an 8-byte field located on a 256-byte boundary that includes the interrupt status. There is, for instance, one interrupt reduction control per EQDIO device.
As an example, interrupt reduction control 520 is in, e.g., control program memory. That way, the adapter module can query this control and can interrupt the control program when there are new received packets ready for it to process, as an example.
Queue Information Block Address 510a: In one example, bytes 0 to 3 of words 12 and 13 of queue descriptor record 502 include, e.g., the 64-bit absolute address of the queue information block (e.g., queue information block 510). It is used by the control program to identify any particular characteristics of the control program or the network interface card, as examples. It is, for instance, a 256-byte field located on, e.g., a 256-byte boundary containing the characteristics. There is, for instance, one queue information block per EQDIO device.
In one example, queue information block 510 may include information which is global to the queues (e.g., all the queues). This may include information like the control program and network interface card capabilities. The control program capabilities include, e.g., the cache line size. The network interface card capabilities include, for instance, protocol offloads, LAN speed, link aggregation functionality, etc.
Key 590: In one example, bits 0 to 3 of byte 0 of word 15 of queue descriptor record 502 include a storage access key to be used by the adapter module, in one example, when accessing the defined EQDIO structures for that device.
Queue Descriptor(s) 540: In one example, words 16 to 16+M of queue descriptor record 502 include queue descriptor 0; and words 16+M+1 to N−1 include queue descriptors 1 up to 31. The total number of queue descriptors is determined by the total of the input and output queues defined for the given EQDIO device. The length of each queue descriptor is dependent on, e.g., the type of EQDIO queue format. The length of each queue descriptor is defined, for instance, in the queue descriptor size field (e.g., queue descriptor size 584). In one example, for EQDIO OSA Hybrid queues, each queue descriptor is, e.g., 12 words in length. Other examples are possible.

Further details of one example of a queue descriptor are described with reference to FIG. 5C. In one example, queue descriptor 540 includes the following information, some of which is also described with reference to FIG. 5A. A queue descriptor, such as queue descriptor 540, may include additional, fewer and/or other information.
Queue ID 542: In one example, byte 0 of word 0 includes the queue ID, which is used to identify a specific queue in the device that corresponds to queue descriptor 540. This is used, for instance, to map the queue into an interrupt reduction control (e.g., interrupt reduction control 520) and is to be unique for each queue defined in the EQDIO subchannel. The queue ID is to be, e.g., 0 for a control plane input/receive (RX) queue and, e.g., 1 for a control plane output/transmit (TX) queue. Any data plane queues, if they are defined will be numbered 2 to 31 and are assigned when each queue is defined. Other examples are possible.
Queue Type 592: In one example, byte 1 of word 0 includes the queue type, which indicates whether the corresponding queue is a control queue, a receive queue, or a transmit queue, etc., as examples. In one example, for format 8 EQDIO queues, the valid values are x′01′ input (receive) data plane, x′81′ output (transmit) data plane, x′40′ input control plane, and x′C0′ output control plane. Other examples are possible.
Storage Block Table (SBT) Address 550a: In one example, words 2 and 3 of the queue descriptor include the storage block table address 550a, which is, for instance, a 64-bit absolute address pointer to the location of the data storage block lists for this queue. The address is, for instance, on a 256-byte cache line alignment and is, e.g., 256-bytes in length.
In one example, storage block table address 550a stores an address that maps to the locations in control program memory of the transmit storage block page entries or receive storage block page entries corresponding to the queue. That way, the adapter module knows where in control program memory the transmit storage block page entries or receive storage block page entries are located.
Queue Format Record Information Block (QFRIB) Address 570a: In one example, words 4 and 5 of the queue descriptor include the queue format record information block address, which is, for instance, a 64-bit absolute address pointer to a location of the queue format record information block for this queue. In one example, queue format record information block address 570a stores an address to a block (e.g., QFRIB 570) that includes specific configuration information for the queue type. Each queue type has its own format and includes, for instance, the storage block page entry ring parameters and queue specific parameters. Each queue format record information block is, for instance, 64-bytes in size.
In one example, a control plane queue format record information block includes, for instance, queue type (e.g., control plane receive queue, control plane transmit queue), version (e.g., control queue QFRIB format), queue format record information block length, queue ID, data storage block page size, total storage block list blocks, data storage block page entry size and max storage block page entry index, etc. Other examples are possible. Different queue format record information blocks may have additional, fewer and/or other information depending on the queue type. Many examples are possible.
The queues are defined, in one example, as circular FIFOs with a max SBPE index indicated in the QFRIB during initialization.
Although examples of a queue descriptor, queue descriptor record and queue structure are provided herein, each may include additional, fewer and/or other information. Many examples are possible. For instance, in one example, the queue descriptor includes a packet completion queue (e.g., EPCQ) storage block table address, which is, for instance, a 64-bit absolute address pointer to a location of a receive packet completion queue storage block table for this queue when it is an input data plane queue. Other examples are possible.

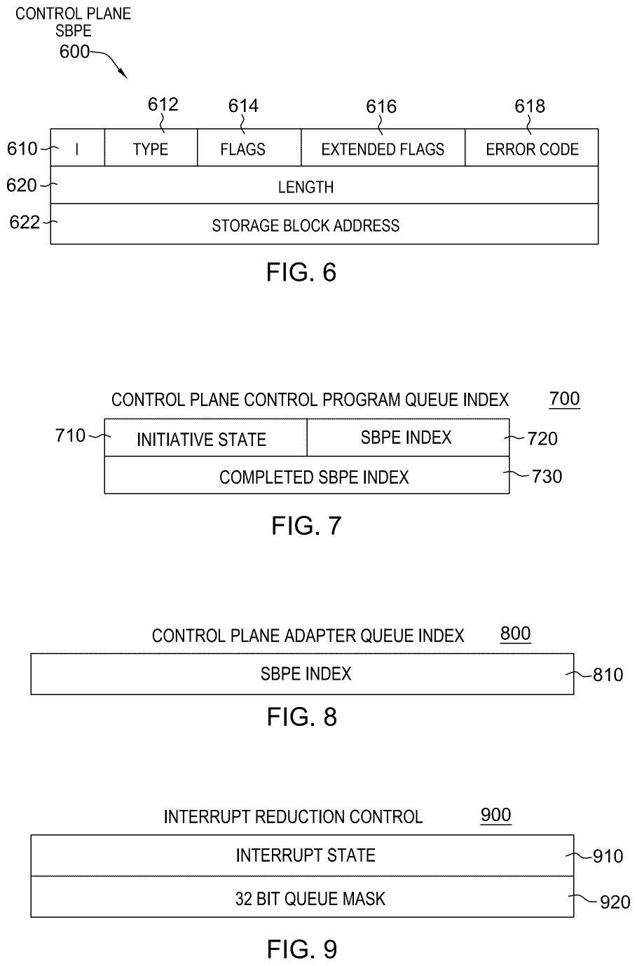

As indicated, in one example, queue structure 500 includes one or more storage block page entries (e.g., storage block page entries 556), an example of which is depicted in FIG. 6. In one example, a control plane storage block page entry 600 (also referred to as entry 600) includes:
I bit 610: In one example, bit 1 of word 0 of entry 600 is an immediate bit (I) set to, e.g., 0 for control data.
Type 612: In one example, bits 2-7 of word 0 of entry 600 include a type that identifies the data type of the corresponding packet, such as 0x01 control packet or a 0x02 Ethernet packet, etc. Other data types are possible.
Flags 614: In one example, byte 1 of word 0 of entry 600 includes one or more flags. For instance, 0x80 is a chaining flag to “chain” together multiple storage block page entries where the data packet is stored in different memory locations or indicate the packet is stored in contiguous memory locations. Flags 614 may also include a flag (e.g., 0x40) to indicate that an interrupt is to be generated by the adapter module when processing the corresponding packet, and/or an error flag (e.g., 0x01), where an error code 618 contains the specific error code. Other examples are possible.
Extended Flags 616: In one example, byte 2 of word 0 of entry 600 includes one or more extended flags that may be reserved for use by the control program executing in, e.g., a logical partition. One example of an extended flag is 0x80—control program lock bit (optional)—that indicates that the storage block address is locked in memory. Other examples are possible.
Error Code 618: In one example, byte 3 of word 0 of entry 600 may include an error code, if generated.
Length 620: In one example, bytes 2-3 of word 1 of entry 600 include a total length of the control payload (e.g., control information and/or data pointed to by the buffer address in the output storage block page entries).
Storage Block Address 622: In one example, bytes 0-3 of words 2-3 include a 64-bit storage block address that supports any byte aligned address. In one example, storage block address 622 may be restricted where address 622 plus length 620 is not to cross, e.g., a 4K boundary, and instead should use chaining in that instance. Other examples are possible.

In one or more examples, the initial EQDIO implementation supports, e.g., a maximum of, e.g., 16 storage block table entries; a page size of, e.g., 4K for the storage block page and other relevant structures; and storage block page entries of either, e.g., 8 or 16 bytes in length. Other examples are possible.

In one example, storage block address 622 indicates a location (e.g., memory location, buffer, etc.) to be used in the control plane. As examples, a control plane SBPE may be for a transmit control plane queue and the location is a location to store, e.g., control plane requests or a receive control plane queue and the location is a receive buffer to store, e.g., control plane replies. Other examples are possible.

Returning to FIG. 5A, as described herein, in one example, an entry 546 of a system queue control array is a 256-byte entry on a 256-byte boundary that includes control program queue index controls (also referred to as control program queue index). The type of control program queue index controls depends on the queue type. For instance, there may be a control plane queue type (control plane transmit queue and/or control plane receive queue), an input data plane queue type and an output data plane queue type, each of which has a control program queue index.

One example of a control plane control program queue index is described with reference to FIG. 7. In one example, a control plane control program queue index 700 includes, for instance:
Initiative State 710: In one example, initiative state 710 is used to determine when initiative is to be provided to the adapter module. This initiative is controlled by, e.g., the millicode. For instance, an update to the control plane control program queue index is executed using an architected instruction, such as a Set Control Program Queue instruction. This instruction causes a branch to, e.g., the control program millicode which interrogates the initiative state to determine if the adapter module is to be given initiative. As examples, 0x80 indicates initiative to be provided to the adapter module and 0x40 indicates initiative given to the adapter module.
Storage Block Page Entry (SBPE) Index 720: In one example, storage block page entry index 720 is initialized to, e.g., 0 by the control program. It indicates, for instance, the next storage block page entry to be used. The adapter module processes up to SBPE Index−1.
Completed SBPE Index 730: In one example, completed storage block page entry index 730 is initialized to, e.g., 0 by the control program and is the SBPE index of the next SBPE which is to be processed by the control program to reclaim allocated resources associated with a transmit request completed by the adapter module. The control program updates this value as transmit resources from previous transmit requests completed by the adapter module are freed. When the control program reclaims the resources associated with the SBPEs processed by the adapter module, the complete SBPE index equals the SBPE index in the adapter queue index. In one example, millicode uses this field to verify the queue is not overrun. For instance, when SBPE index+1 equals the completed SBPE index, the queue is full and no new transmit requests are to be added.

In one example, the control program uses architected instructions (e.g., a Set Control Program Queue Controls instruction and an Extract Control Program Queue Controls instruction), described below, to access the control program queue area. The adapter module firmware has direct access to this area. The SBPE index is incremented for new transmit requests and to allocate receive buffer resources. The completed SBPE index is incremented when the resources associated with a completed transmit and receive request have been freed by the control program.

As examples, a control plane control program queue index may be a transmit control plane control program queue index or a receive control plane control program queue index. For instance, both queue indices are defined, each having the same format.

In one example, in addition to the control plane control program queue indices, there is a receive control plane adapter queue index and a transmit control plane adapter queue index. The transmit adapter queue index area is updated when the adapter module processes transmit requests and the receive adapter queue index is updated when the adapter module replies to a control primitive request or when the adapter module initiates a control primitive request, as described herein.

The size of an adapter queue index area is, e.g., 8 bytes due to the indexing used to access the proper adapter queue index area associated with the defined queue ID (because the adapter queue index areas are allocated in the same 256 byte area in the hardware system area). The control program uses, for instance, an architected instruction (e.g., a Store Adapter Indices instruction) to access this area. The adapter module firmware has direct access to the area.
One example of a control plane adapter queue index is described with reference to FIG. 8. In one example, a control plane adapter queue index 800 includes (regardless of whether it is a transmit or receive control plane adapter queue index):
Storage Block Page Entry Index 810: In one example, storage block page entry index 810 is, e.g., 16 bits, and is, for instance, initialized to, e.g., 0 by the adapter module and is an index of a next SBPE to be updated by the adapter module. In one example, the adapter module has processed up to SBPE Index−1.

In one example, the control plane control program queue index and the adapter module queue index areas control transmission of control command payloads for the transmit control queue. They control allocation of control program buffer resources for received adapter control command responses and adapter initiated control command payloads for the receive control queue.

In one or more aspects, the control plane queue indices are set and/or read by one or more architected instructions, such as a Set Control Program Queue Controls (SCPQC) instruction, an Extract Control Program Queue Controls (ECPQC) instruction and a Store Adapter Indices (STAI) instruction, each of which is described below.

In one example, execution of the Set Control Program Queue Controls instruction includes setting one or more control program (CP) queue index controls (e.g., control plane control program queue index 700) for one EQDIO input queue or output queue, specified by a general register field of the instruction (e.g., R3 of the instruction), to the value specified by, e.g., selected bits of bits 8 to 63 of the second operand of the instruction (e.g., R2 of the instruction). The result is indicated in a condition code of the instruction, as an example.

As indicated, in one example, selected bits of bits 8-63 of general register R2 are used to specify the control program queue index controls values to be set in the form of a control program queue index controls area (e.g., control plane control program queue index 700). In one example, bits 0-7 of general register R2 are not used to set the Initiative State (IS) in the control program queue index and are ignored. The instruction execution based on the index values determines the Initiative State (IS) value, in one example.

In one example, based on executing the Extract Control Program Queue Controls instruction, the current contents of the 64-bit control program queue controls for a particular enhanced QDIO input queue or output queue (e.g., control plane control program queue index 700), specified by the second operand, is extracted and placed in the first operand (e.g., R1). General register 1 contains the subchannel token that designates the enhanced QDIO active subchannel that is to have one of its control program queue indices extracted. If the subchannel is not in the QDIO active state, then condition code 1 is set, in one example, and the condition code qualifier (CCQ) field in general register R1+1 is set with, e.g., a value of 63. A subchannel token is obtained via, e.g., a Channel Subsystem Call (CHSC) Store-Subchannel-QDIO-Data Command that obtains selected information, such as the subchannel token, and stores it in a control block. The subchannel token is set by the control program, in one example. In other examples, one or more queues may be specified.

In execution of the Store Adapter Indices instruction, in one example, current contents of the adapter queue controls structure for EQDIO input queues and output queues (e.g., control plane adapter queue index 800) are extracted and stored into a selected location, such as the logical storage location specified by the second operand (e.g., address in register B2 concatenated with DL2 and DH2). The result is indicated in the condition code.

Further details relating to the interrupt reduction control (IRC) (e.g., interrupt reduction control 520) are described with reference to FIG. 9. In one example, this control area is used to control interrupt generation between the control program and the adapter module. The queue ID, in one example, is used to map to an individual bit of the queue mask, described herein. Each receive and transmit queue (control and data planes) maps one to one to bits in the queue mask, in one example.

In one example, an interrupt reduction control 900 is used to communicate the interrupt state (e.g., interrupt state 910) between a control program and the adapter module. In one example, interrupt reduction control 900 includes:

Interrupt State 910 (e.g., one byte): In one example, byte 0 of word 0 includes the interrupt state that contains shared state information. The control program sets a state to indicate to the adapter module that it is to generate an interrupt. The adapter module may set a state when the interrupt is generated.

Examples of interrupt state 910 include:
Single Interrupt—0x00
   The entire 8-bytes of the interrupt reduction control are to be, e.g., zero for the adapter module to place the interface into “Single Interrupt” state. It is the control program's responsibility to verify the interrupt reduction control is, e.g., all zeros to set the interface to “Single Interrupt” with, e.g., a compare and swap instruction or by another mechanism.
   In one example, the control program is responsible for setting the interrupt reduction control to, e.g., all zeros. The adapter module relies on this setting to initiate the interrupt to the control program. The adapter module can set the interrupt state to “no interrupt state” from the “single interrupt” state. The control program can change the interrupt state at any time, in one example.
   Set by the control program when it wants an adapter interruption to signal the arrival of new incoming work.
   Initialization State
   Results in an adapter module interruption to be initiated on the next adapter queue index update by the adapter module or when processing a transmit storage block page entry with a program-controlled interruption request turned on by the control program.
   The adapter changes the interface state to “No Interrupt” state, in one example.
No Interrupt—0x80
   Set by the adapter module when an adapter interruption is generated.
   No additional adapter module interruptions are to be initiated by the adapter module until the control program places the interface back into “Single Interrupt” state. The adapter module updates, e.g., the 32-bit queue mask for any additional incoming data or program-controlled interruptions.
No Interrupt—Processing State—0x81
   Set by the control program whenever it starts processing inbound data-used by the adapter module when processing “Threshold A” limits set by a control program in the queue format record information block.
Queue Mask 920 (e.g., 32 bits in word 1), which maps to the queue ID specified in the queue descriptor. There is one bit per queue ID, as an example.
Queue Mask—32 Bit Format Example:
   Queue ID 0—Input (RX) Control Queue assigned to Queue Mask 0 (0x80000000—Bit 0).
   Queue ID 1—Output (TX) Control Queue assigned to Queue Mask 1 (0x40000000—Bit 1).
   Queue ID 2 to the Maximum Supported Queue ID by the adapter module returned by a CHSC (Channel Subsystem Command) x ‘24’ format 1 instruction for all selected transmit and receive data plane queues.

In one or more aspects, to support additional features which use selected processing by the adapter module for specific inbound packets (e.g., Ethernet packets), a series of adapter module managed receive queues are defined, in one example. These receive queues are defined to interact between the adapter module and the network interface card.

The following is a description of these selected receive queues and the features they are used for:
MAC (Media Access Control) Address Learning Queue—This queue is configured by the adapter module to have received packets (e.g., Ethernet packets) which do not match any EQDIO registered MAC address forwarded by the network interface card to this queue. This enables the MAC learning function to be performed by the adapter module and interact with a virtual switch configured in the MAC learning mode.
LLDP (Link Level Discovery Protocol) Queue—This queue is configured by the adapter module to have received packets (e.g., Ethernet packets) with a destination MAC of the network interface card burned-in-address forwarded by the network interface card to this queue. This enables the adapter module to isolate the Ethernet control traffic from normal network traffic.
ARP (Address Resolution Protocol) Offload Queue—This queue is configured by the adapter module to have received address resolution protocol traffic forwarded by the network interface card to this queue. This enables the adapter module to perform address resolution offload and address resolution offload filtering functions when configured by a control program.
VLAN (Virtual Local Area Network) Discovery Queue—This queue is configured by the adapter module to have received Ethernet traffic which contains a registered VLAN ID, but the corresponding MAC Address is not associated with the VLAN ID be forward to this queue. This enables the adapter module to perform a VLAN discovery feature. The adapter module verifies the MAC address has been registered by the same EQDIO interface which registered the matching VLAN. If so, the appropriate configuration of the MAC with the VLAN is performed by the adapter module. This function is used, e.g., for hypervisors who register large groups of MAC addresses and VLAN IDs separately.
Network Traffic Analyzer Queue—This queue is configured by the adapter module to have received Ethernet traffic matching a configured set of Ethernet packet contents to this queue. This enables the adapter module to provide a Network Traffic Analyzer function if configured.

Other examples are possible.

Although one example of a queue structure and its components are described herein, each component and/or the queue structure itself may have additional, fewer and/or other components/fields/information. The examples provided herein are just examples and not meant to be limiting in any way. Further, although specific locations, specific fields and/or specific sizes of the fields may be indicated (e.g., specific bytes and/or bits), other locations, fields and/or sizes may be provided. Further, although the setting of a bit to a particular value, e.g., one, zero, other value, may be specified, this is only an example. The bit, if set, may be set to a different value, such as the opposite value or to another value, in other examples. Many variations are possible.

In one or more aspects, the enhanced queued direct input/output queues are used in communication between at least one control program and a network interface card. To facilitate communications, an adapter module is used. In one example, the adapter module uses the information in a queue descriptor record (e.g., queue descriptor record 502), transmitted from the control program to the adapter module, to establish the receive and transmit queues that permit the control programs and the network interface card to communicate with one another using the adapter module and the queues.

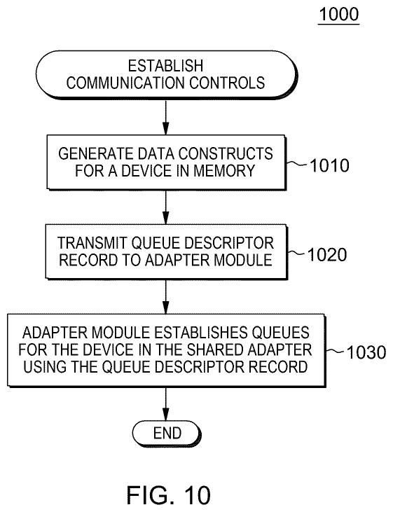

In one example, communication controls processing is established. One example of such processing is described with reference to FIG. 10. In one example, an establish communication controls process 1000 (also referred to as process 1000) is executed by one or more computing devices (e.g., one or more computers, such as computer(s) 101 and/or other computers; one or more servers, such as remote server(s) 104 and/or other remote servers; one or more devices, such as end user device(s) 103 and/or other end user devices; one or more processors or nodes, such as processor(s) or node(s) of processor set 110 (e.g., processor 250) and/or other processor(s) or node(s); processing circuitry, such as processing circuitry 120 of processor set 110 and/or other processing circuitry; and/or other computing devices, etc.). Additional and/or other computers, servers, devices, processors, nodes, processing circuitry and/or computing devices may be used to execute the processing and/or aspects thereof. Many examples are possible.

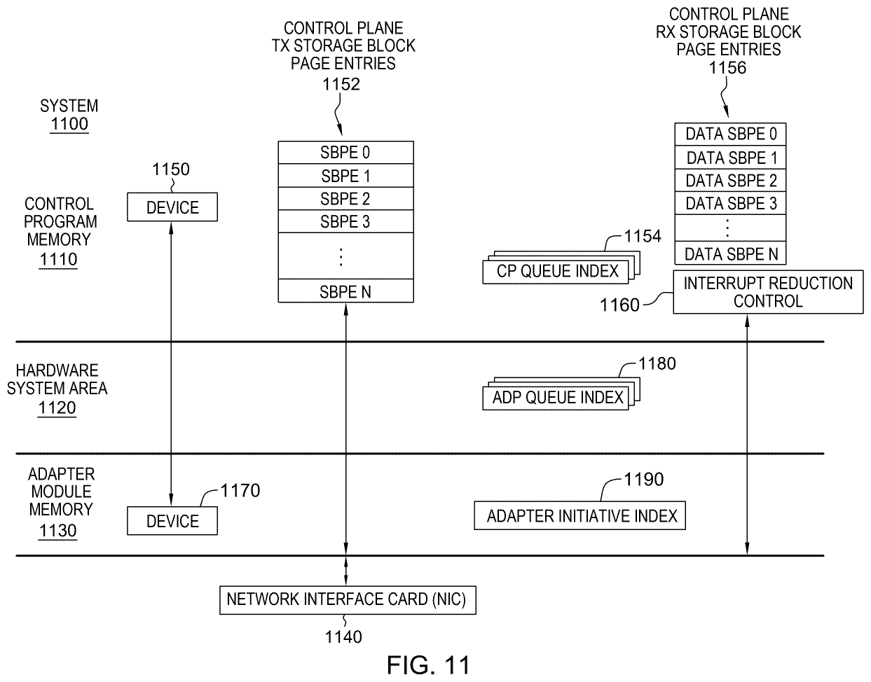

In one example, process 1000 generates 1010 one or more data constructs (e.g., components) of a queue structure for a device in memory (e.g., control program memory). For example, as depicted in FIG. 11, in a shared resource system 1100, a control program executing within system 1100 (e.g., on a computing device) generates the following data constructs for a device (e.g., device 1150) and stores them in memory (e.g., control program memory 1110): control plane transmit storage block page entries 1152, one or more control program queue indices 1154, one or more control plane receive storage block page entries 1156, and/or an interrupt reduction control 1160, as examples. In other examples, it generates data plane transmit storage block page entries, data plan receive storage block page entries and/or receive packet completion queue entries defined for data plane receive data queues. Additional, fewer and/or other data constructs of one or more queues may be generated.

In one example, during EQDIO initialization, the control program configures the following, as examples: the number of, e.g., data plane receive data buffer storage block page entries to be grouped in a single virtual buffer-currently set to, e.g., 32; the cache line byte boundary-currently set to, e.g., 256; the number of receive data buffer storage block page entry entries; and/or the number of receive packet completion queue (e.g., EPCQ) entries; and/or inbound packing parameters, such as, for instance, latency timer to trigger when an idle interface starts receiving traffic; streaming timer which goes into effect once a connection is detected to be in a streaming mode; and/or a packet count which indicates maximum packets which can be received without a control program notification. Additional, fewer and/or other inbound packing parameters and/or configuration parameters may be defined.

Based on generating the one or more data constructs for the device (e.g., device 1150) in memory (e.g., control program memory 1110), process 1000 transmits 1020 a queue descriptor record associated with the one or more generated data constructs to the adapter module executing on a computing device of system 1100. For instance, the control program transmits the queue descriptor record (e.g., queue descriptor record 502) to the adapter module via devices 1150 and 1170. The computing device executing the adapter module may be the same or different from the computing device executing the control program. In one example, the queue descriptor record is transmitted via, e.g., an Establish-QDIO-Queues Channel Command Word (CCW) of a Start Subchannel instruction. Other mechanisms for providing the queue descriptor record to the adapter module may be used.

Using the queue descriptor record, the adapter module (via, e.g., process 1000 or another process) establishes 1030 one or more queues (e.g., data constructs) for a device (e.g., device 1170) in e.g., adapter module memory 1130 coupled to the control program. In one example, the adapter module establishes transmit and receive control queues for establishing the control plane and then establishes transmit and receive data queues for the data plane subsequent to the control plane being established. Other examples are possible.

In one example, 32 receive data storage block page entries are grouped together to define, e.g., a single 128K block. In establishing the receive data queues, as an example, the adapter module (e.g., EQDIO adapter code) builds, e.g., a single 128K virtual address and maps the 32 receive data storage block page entries to back the virtual address, giving the physical network interface card a single contiguous 128K block. In one example, 32 is a configurable parameter, which is set, e.g., in the EQDIO initialization process. It is included, e.g., in a control block exchanged prior to execution of the establish queues, in one example. Other examples are possible.

In one example, once the one or more queues are established (e.g., the control program generates the queue(s) (e.g., data constructs for the queue(s)), provides the queue descriptor record for the queue(s) to the adapter module and the adapter module establishes the queue(s)), the queue(s) are activated (e.g., via an Activate Channel Command Word) by the control program. Based thereon, communication between the control program and the adapter module is via, e.g., the EQDIO processing and the established queue(s). Channel command word processing is not used, in one example, for further communication between the control program and the adapter module.

After initializing the EQDIO parameters described herein, the control program allocates a set of receive data storage block page entries in the defined group and notifies the adapter module, using the initiative state, that the first set of receive data storage block page entries are available. At this point the control program notifies the adapter module that inbound packets can be accepted.

As indicated, in one or more aspects, the queue descriptor (QD) and queue descriptor record (QDR) are referenced during an establish queues process. After the establish queues process is complete, the queue descriptor and queue descriptor record may be deallocated in memory. The firmware copies this information, in one example, during the establish queues process.

Further details of selected components of FIG. 11 are described herein. As depicted in FIG. 11, system 1100 includes, for instance, control program memory 1110 (e.g., memory owned by the control programs and/or logical partitions), a hardware system area (HSA) 1120 (e.g., selected memory that includes configuration information), and adapter module memory 1130 (e.g., memory owned by the adapter module). Adapter module memory 1130 includes, e.g., an adapter module (e.g., EQDIO adapter code) that serves as an interface between, e.g., a network interface card (NIC) 1140 and the logical partitions (e.g., the control programs).

In one example, the data constructs in control program memory 1110 include device 1150, control plane transmit storage block page entries (SBPE) 1152, one or more control program queue indices 1154, control plane receive storage block page entries 1156 and an interrupt reduction control 1160. Additional, fewer and/or other components/constructs may be a part of control program memory 1110. For instance, in one example, one or more of data plane transmit storage block page entries, data plane receive storage block page entries and receive packet completion queue entries may be included in control program memory. Other examples are possible.

In one example, device 1150 establishes a connection between the control program and device 1170 in adapter module memory 1130 and is used for communications between the control program and the adapter module prior to establishing a queue (e.g., the data constructs/components of the queue). Each logical partition (or each control program in the logical partition) that wishes to use network interface card 1140 may create its own device 1170. Device 1150 can include (or have associated therewith) any number of data queues that rely on the data constructs described herein to facilitate communication between the control program and the adapter module and/or network interface card. For example, there can be a configurable number of data queues which can be any mix of transmit (TX) or receive (RX) queues. In one embodiment, there is at least one data plane transmit queue and one data plane receive queue. In addition, a device (e.g., device 1150, device 1170) includes at least one pair of control queues (i.e., one control plane transmit queue and one control plane receive queue). Other examples are possible.

In one example, storage block page entries 1152 contain pointers to control information which is used to pass configuration or debug types of information between the control program and the adapter module. In one example, a control plane storage block page entry of a transmit queue (e.g., entry 1152) includes an indication (e.g., an address) of a location in memory (e.g., a buffer) that includes control request information (e.g., an ARP request primitive) to be transmitted from the control program to the adapter module. Further, a control plane storage block page entry of a receive queue (e.g., entry 1156) includes an indication (e.g., an address) of a location in memory (e.g., a buffer) that includes control reply information (e.g., an ARP reply primitive) to be provided to the control program from the adapter module. Other examples are possible.

In one embodiment, each control plane queue includes its own control program queue index 1154 and adapter (ADP) queue index 1180 (e.g., control plane control program queue index 700, control plane adapter queue index 800).

Interrupt reduction control 1160 is set by the adapter module when, e.g., an interrupt is generated. In one embodiment, interrupt reduction control 1160 includes an interrupt state (e.g., one byte; e.g., interrupt state 910) which the control program sets to indicate when an interrupt is to be provided. For example, if the control program has finished processing the received packets, in one example, the control program sets the interrupt state to indicate it is idle. Thus, if the adapter module receives additional packets, it can use the interrupt state to determine whether it should then send an interrupt to the control program. For example, if the interrupt state indicates that the control program is not currently processing data in the receive queues, then, in one example, the adapter module sends an interrupt to the control program. However, if the interrupt state indicates the control program is currently processing receive packets, an interrupt is not needed. Other examples are possible.

Moreover, in one embodiment, interrupt reduction control 1160 includes, in one example, a bit mask (e.g., mask 920) where each bit corresponds to a queue ID of a queue corresponding to (e.g., in or associated with) the device (e.g., device 1150). The adapter module uses the bit mask to indicate which queues have data ready to be processed by the control program. While there may be multiple queues for data device 1150, there is one interrupt reduction control 1160 for each device 1150, in one example.

Hardware system area 1120 is a selected memory area used for hardware configuration tables. In this example, hardware system area 1120 includes one or more adapter queue indices 1180. In one embodiment, an adapter queue index 1180 is read/written by the adapter module and read by the control program. The adapter module updates adapter queue index 1180. There are different types of adapter queue indices that may be stored in the hardware system area and used in EQDIO processing, including, but not limited to, a transmit control plane adapter queue index and a receive control plane adapter queue index, each of which has a same format, an example of which is depicted in FIG. 8. There may also be data plane transmit and receive adapter queue indices. A transmit adapter queue index is used by the adapter module to indicate the completion of a control plane request or the completion of a packet transmission. During transmission, the adapter module receives transmit completions and updates the transmit adapter queue index. As such, a transmit adapter queue index stores, in one example, the next transmit storage block page entry index to be consumed by the adapter module. Control program queue index 1154 indicates the next entry which will contain a new transmit control or data request.

In addition to device 1170, adapter module memory 1130 also includes, in one example, an adapter initiative index 1190. This data construct is used by the control program, in one example, to interrupt or wake up the adapter module when the control program has packets ready to be transmitted. The adapter module uses a control program queue index 1154 (e.g., a data plane control program queue index) to retrieve data plane transmit storage block page entries and program the network interface card to fetch the corresponding transmit packets from control program memory 1110 using the pointers in the data plane transmit storage block page entries. In one example, when adapter initiative index 1190 is used, the control program copies the contents of control program queue index 1154 into the adapter initiative index 1190. The adapter module can then directly fetch the transmit storage block page entries corresponding to the queue index without fetching control program queue index 1154.

In one or more aspects, the EQDIO queues and protocols are used to receive data by a control program (e.g., a host operating system) from a network interface card using an adapter module. The EQDIO protocol is used to efficiently execute in a highly virtualized environment. This highly virtualized environment enables the configuration of a large number of control programs (e.g., host control programs; for example, 2K) to share a single network interface card. Each control program can define up to, e.g., 32 unique queues on its specific interface. Each EQDIO queue is configured with its own specific packet criteria and each is defined by its queue structure.

Each EQDIO interface can have multiple configured EQDIO receive (RX) queues, each having a unique set of routing rules used to demultiplex received packets (e.g., Ethernet packets) into a specific queue. The number of EQDIO receive queues is configured at EQDIO initialization time by the specific control program, as an example. In one or more aspects, each receive (RX) queue is defined by a unique queue descriptor (e.g., queue descriptor 540).

In one or more aspects, the EQDIO control plane queues (e.g., control plane output (transmit) queue and control plane input (receive) queue) facilitate communications within the computing environment, including communication between computing devices, e.g., in one or more logical partitions, communications between computing devices and a network interface card, etc. Communication is facilitated by enabling communications between the computing devices and/or the network interface card without going to the local area network. Instead, as an example, one control program on one computing device (e.g., within one logical partition) sends a command to the adapter module to obtain an address for another computing device (e.g., in the same or another logical partition) and uses that address to send the data to, e.g., another control program on the other computing device. Other examples are possible. The control program and the adapter module use, in accordance with one or more aspects of the present disclosure, an address resolution protocol across the control plane to obtain the requested address.

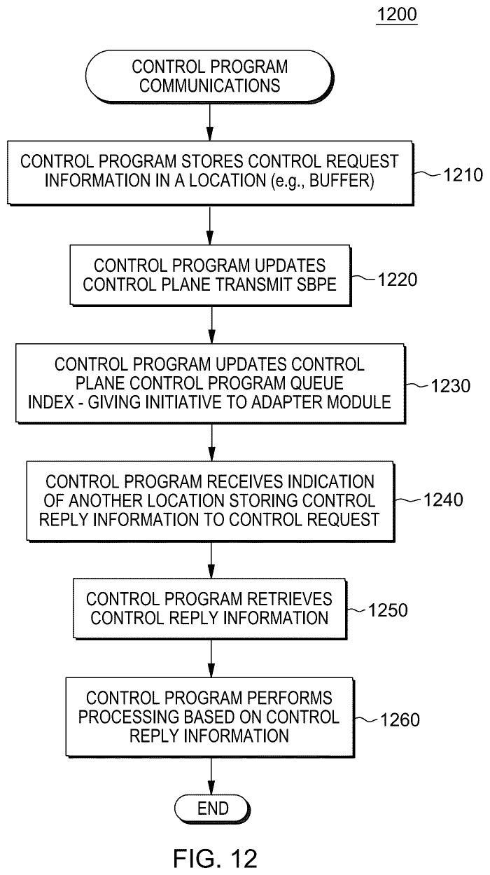

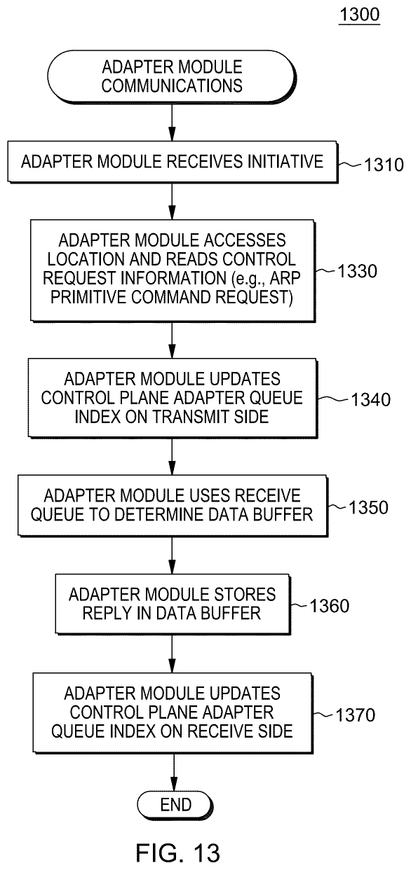

Further details of communication between a control program and the adapter module across the control plane are described with reference to FIGS. 12-13. FIG. 12 depicts one example of control program communications processing and FIG. 13 depicts one example of adapter module communications processing.

In one example, referring to FIG. 12, a control program communications process 1200 (also referred to as process 1200) is executed by and/or using one or more computing devices (e.g., one or more computers, such as computer(s) 101 and/or other computers; one or more servers, such as remote server(s) 104 and/or other remote servers; one or more devices, such as end user device(s) 103 and/or other end user devices; one or more processors or nodes, such as processor(s) or node(s) of processor set 110 (e.g., processor 250) and/or other processor(s) or node(s); processing circuitry, such as processing circuitry 120 of processor set 110 and/or other processing circuitry; and/or other computing devices, etc.). Additional and/or other computers, servers, devices, processors, nodes, processing circuitry and/or computing devices may be used to execute the process and/or portions thereof. Many examples are possible.

In one example, process 1200 includes the control program storing 1210 control request information in a location, such as a memory location, buffer, etc. The control request information includes, for instance, an address, an address resolution protocol (ARP) primitive, examples of which are described herein, and/or other request information, etc. Based on storing the control request information in the location, the control program updates 1220 a control plane transmit storage block page entry (e.g., entry 1152) to indicate the location of the control request information. Further, in one example, the control program updates 1230 a control plane control program queue index (e.g., a transmit control plane control program queue index having, e.g., the format depicted in FIG. 7). For instance, it updates an SBPE index (e.g., SBPE index 720) to indicate the SBPE that includes the control request information and gives initiative to the adapter module by updating the initiative state (e.g., initiative state 710). Other examples are possible.

Based on the adapter module receiving initiative, the adapter module processes the request, and, in one example, the control program receives 1240 an indication of another location (e.g., memory location, buffer) storing control reply information (e.g., an address, an ARP Reply primitive, and/or other reply information, etc.). For example, the control program obtains the indication of the location (e.g., buffer) using the receive control plane adapter queue index (e.g., index 800). Other examples are possible.

The control program retrieves 1250 the control reply information from the location and performs 1260 processing based on the control reply information. For example, the control program informs the adapter module to perform ARP processing associated with an IP address (e.g., issues an ARP_SETIP Request), adds an address to its ARP cache, updates the ARP cache, purges a cache entry, performs one or more other offload and/or ARP functions, defines an address for filtering, performs one or more other filtering functions, etc. Many examples are possible.

One example of the processing performed by the adapter module is described with reference to FIG. 13. In one example, referring to FIG. 13, an adapter module communications process 1300 (also referred to as process 1300) is executed by and/or using one or more computing devices (e.g., one or more computers, such as computer(s) 101 and/or other computers; one or more servers, such as remote server(s) 104 and/or other remote servers; one or more devices, such as end user device(s) 103 and/or other end user devices; one or more processors or nodes, such as processor(s) or node(s) of processor set 110 (e.g., processor 250) and/or other processor(s) or node(s); processing circuitry, such as processing circuitry 120 of processor set 110 and/or other processing circuitry; and/or other computing devices, etc.). Additional and/or other computers, servers, devices, processors, nodes, processing circuitry and/or computing devices may be used to execute the code process and/or portions thereof. Many examples are possible.

In one example, process 1300 includes the adapter module receiving 1310 initiative. Based on receiving initiative, the adapter module accesses 1330 the location (e.g., memory location, buffer) storing the control request information (e.g., an address, an ARP primitive command request, etc.) and reads the control request information. The adapter module determines the location via the SBPE index of the control plane transmit queue.

The adapter module updates 1340 a control plane adapter queue index (e.g., control plane adapter queue index 800) on the transmit side (e.g., a transmit control plane adapter queue index having the format depicted in FIG. 8). For instance, it increases SBPE index 810, e.g., by 1.

Further, in one example, the adapter module uses 1350 the control plane receive queue to determine a location (e.g., data buffer) to place a reply to the control request information. For instance, it uses the SBPE of the receive queue to determine the location.

The adapter module stores 1360 the reply in the location determined using the control plane receive queue SBPE. The reply includes, in one example, control reply information, such as an address, an ARP primitive command reply and/or other reply, etc.

Based on storing the reply, the adapter module updates 1370 a control plane adapter queue index (e.g., control plane adapter queue index 800) on the receive side (e.g., a receive control plane adapter queue index having the format depicted in FIG. 8). For instance, it increases SBPE index 810, e.g., by 1.

In one example, the communication described with reference to FIGS. 12-13 is used in address resolution protocol (ARP) processing (and/or other processing, etc.). In one example, address resolution protocol processing, including but not limited to, ARP offload processing and/or ARP filtering processing, uses address resolution protocol code (e.g., address resolution protocol code 150). The code is, e.g., computer-readable program code (e.g., instructions) in computer-readable storage media, e.g., storage (persistent storage 113, cache 121, storage 124, other storage, as examples). The computer-readable storage media may be part of one or more computer program products and the computer-readable program code may be executed by and/or using one or more computing devices (e.g., one or more computers, such as computer(s) 101 and/or other computers; one or more servers, such as remote server(s) 104 and/or other remote servers; one or more devices, such as end user device(s) 103 and/or other end user devices; one or more processors or nodes, such as processor(s) or node(s) of processor set 110 (e.g., processor 250) and/or other processor(s) or node(s); processing circuitry, such as processing circuitry 120 of processor set 110 and/or other processing circuitry; and/or other computing devices, etc.). Additional and/or other computers, servers, devices, processors, nodes, processing circuitry and/or computing devices may be used to execute the code and/or portions thereof. Many examples are possible.

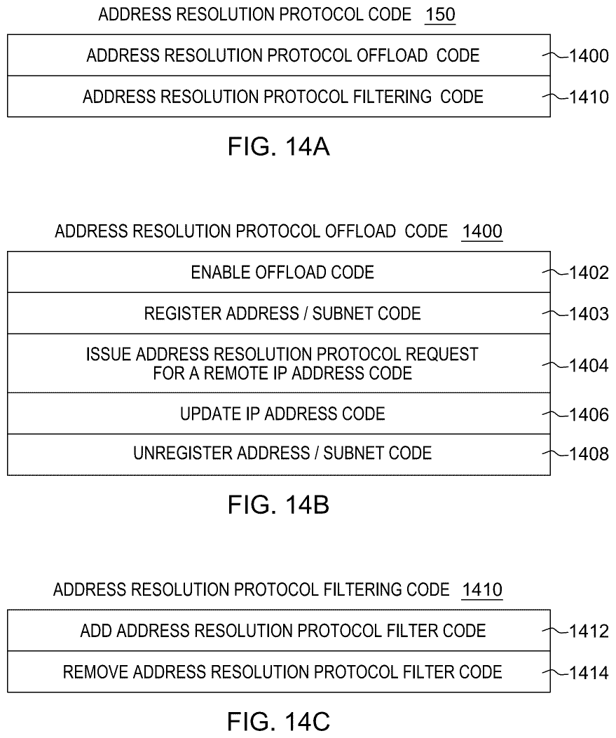

In one example, referring to FIG. 14A, address resolution protocol code 150 includes address resolution protocol offload code 1400 to offload address resolution protocol processing to the adapter module; and address resolution protocol filtering code 1410 to perform address resolution protocol filtering.

Further details relating to address resolution protocol offload code 1400 are described with reference to FIG. 14B. In one example, address resolution protocol offload code 1400 includes enable offload code 1402 to be used to enable address resolution protocol offload processing; register address/subnet code 1403 to be used to register an address and/or subnet; issue address resolution protocol request for a remote IP address code 1404 to be used to request address resolution protocol for a remote IP address; update IP address code 1406 to be used to add an IP address; and unregister address/subnet code to be used to unregister an address and/or subnet. Address resolution protocol offload code 1400 may include additional, less and/or other code. Many examples are possible.

Further details relating to address resolution protocol filtering code 1410 are described with reference to FIG. 14C. In one example, address resolution protocol filtering code 1410 includes add address resolution protocol filter code 1412 to be used to add address resolution protocol filtering; and a remove address resolution protocol filter code 1414 to be used to remove address resolution protocol filtering. Address resolution protocol filtering code 1410 may include additional, less and/or other code. Many examples are possible.

Although address resolution protocol code 150 is depicted in persistent storage 113, one or more code portions may be in other locations, other than persistent storage 113. Further, in one or more examples, different cores of one processor or multiple processors may execute the code portions. Many examples are possible.

In one or more aspects, the address resolution protocol offload functionality enables the control program to transfer address resolution protocol ownership of a specific IP address and IP subnet to the EQDIO adapter module. As examples, the address resolution protocol offload code can handle both the IPV4 address resolution protocol and the IPV6 Neighbor Discovery protocol. Other examples are possible.

In one or more aspects, the EQDIO architecture defines a control plane which is used to exchange control primitives between the control program and the adapter module (e.g., EQDIO adapter module).

When the address resolution protocol offload subcommand is used, it causes (e.g., immediately) the address resolution protocols to be blocked from the issuing EQDIO interface data plane and, in one example, only address resolution protocol communication related to the registered address(es) (e.g., IPV4 or IPV6 address(es)) will occur over the control plane. Address resolution protocol traffic not related to, e.g., selected addresses, such as IPV4 address(es) and/or IPV6 addresses, are filtered from the control program. Other examples are possible.

To provide offload processing, in one example, address resolution protocol offload primitives are used. Example primitives and how they are used in the address resolution protocol offload process are described below. As examples:
ARP_SETIP—This primitive is used by the control program to register an IP address and IP subnet. Based on being registered, the EQDIO adapter module takes ownership for the address resolution protocol responsibility for the address if it is, e.g., an IPV4 address and Neighbor Discovery responsibility for an IPV6 address. The primitive also registers the MAC address and VLAN ID to be associated with the IP address. This enables a vSwitch or hypervisor the capability of offloading the address resolution protocol responsibility of the entire vSwitch or hypervisor. Address resolution protocol ownership has the following responsibilities which are handled by the adapter module, in accordance with one or more aspects of the present disclosure:
   All GRAT (gratuitous) address resolution protocol processing to verify the address is not a duplicate in the network. If it is found to be a duplicate, the adapter module sends a reply to the control program to indicate this. The control program has the capability to set an indicator to ignore duplicates for the case in which the IP address is being migrated.
   The adapter module maintains a local address resolution protocol cache which contains ARP_SETIP IP addresses registered across the EQDIO interfaces.
   Any address resolution protocol request received with a target protocol address matching the IP address specified in the ARP_SETIP is replied to by the adapter module. Other address resolution protocol requests received are not replied to by the adapter module, in one example.
   Any GRAT address resolution protocols received with a source protocol address on the same IP Subnet as registered by the ARP_SETIP is forwarded to the control program to update the address resolution protocol cache.
   Any Null GRAT address resolution protocols received are forwarded to the control program. This causes control program address resolution protocol cache entries containing the sender hardware address to be removed.
ADD_ARP_CACHE—This primitive is used by the control program to request an address resolution protocol request for a remote IP address. The adapter module performs the following, in one example:
   Verify the target protocol address is on the same IP subnet as the source protocol address. If not, the adapter module returns the appropriate error.
   Search the local address resolution protocol cache to determine if the target protocol address is registered by an EQDIO interface on the same adapter. If so, the MAC address of the local partition (LPAR) is returned to the control program in the primitive reply and a flag is set to indicate the address is considered “Local”.
   Build the address resolution protocol request and send it to the network. The MAC address and VLAN ID specified with the primitive are used in the address resolution protocol request. If an address resolution protocol reply is received, the sender hardware address is returned to the control program. The adapter module indicates if the remote IP address is accessible in another control program partition (LPAR) via another EQDIO interface on the same adapter.
   The adapter module handles the requested address resolution protocol retries based on the value specified by the control program in the primitive.
   If no address resolution protocol reply is received, the adapter module returns the appropriate error.
Update_ARP_Cache—This primitive is sent by the adapter module to the control program to add an IP address to the control program address resolution protocol cache. The following events trigger the sending of the Update_ARP_Cache primitive, as an example:
   If an address resolution protocol request is received which contains a target protocol address matching the IP address previously registered with the ARP_SETIP.
   If a GRAT address resolution protocol request is received with a source protocol address on the same IP subnet previously registered with the ARP_SETIP. This causes the control program to update the address resolution protocol cache with the new sender hardware address if present. The control program can also add the source protocol address to its ARP cache if it was not previously present.
   Any Null GRAT address resolution protocol request received. This causes the control program to purge any address resolution protocol cache entries containing the source hardware address in the control program address resolution protocol cache.
   Any address resolution protocol request containing a null sender hardware address source and a source protocol address on the same IP subnet previously registered with the ARP_SETIP. This causes the control program to remove the source protocol address from the address resolution protocol cache if present.
   Notify the control program of a duplicate IP address detection for a previously issued ARP_SETIP.

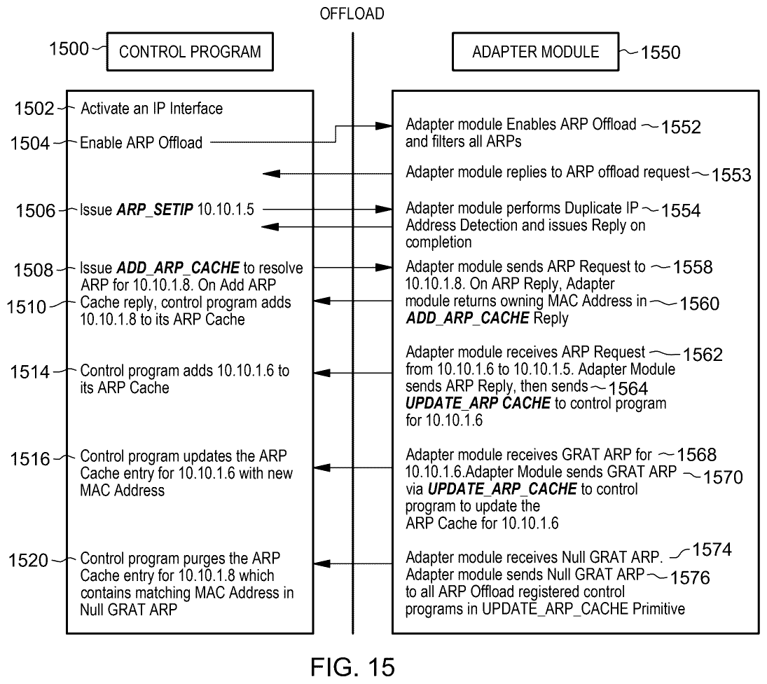

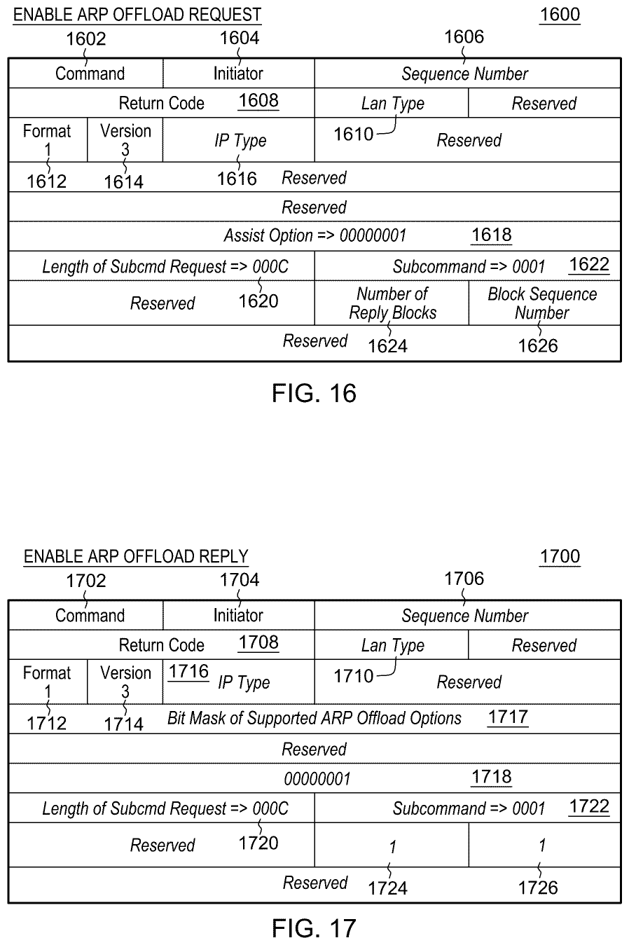

Further details of the offload process are described with reference to FIGS. 15-27. For example, FIG. 15 depicts one example of a flow of offload functions, and FIGS. 16-27 depict example primitives (e.g., requests and replies) used for the offload process.

Referring initially to FIG. 15, a control program 1500 activates 1502 an IP interface. For instance, a TCP/IP stack is started by an operating system and a Host IP Address is defined. This enables a control program to communicate across an IP Network using the defined Host IP Address. The control program then issues an ARP_SETIP using the defined Host IP Address to the adapter module. The adapter module then performs the ARP processing for this Host IP Address.

Control program 1500 enables 1504 an address resolution protocol (ARP) offload process (e.g., using enable offload code 1402). In one example, to enable ARP offload, the control program transmits control request information (e.g., an enable offload request, such as an Enable_ARP_Offload Request primitive) to an adapter module (e.g., adapter module 1550). For instance, the control program places (e.g., stores) the enable offload request in a location (e.g., buffer) and the control program updates the transmit control plane control program queue index to give initiative to the adapter module. The adapter module obtains the control request information (e.g., enable offload request) and provides a reply, if warranted, as described with reference to FIG. 13.

One example of an Enable_ARP_Offload Request primitive is described with reference to FIG. 16. In one example, an Enable_ARP_Offload Request Primitive 1600 includes a plurality of fields, including, for instance:
Command 1602: Command specifying the request (e.g., Enable_ARP_Offload);
Initiator 1604: Entity issuing the primitive (e.g., 0x00—Control program initiated; 0x01—Adapter module initiated);
Sequence Number 1606: Value used to match a reply with the request;
Return Code 1608: Return code associated with the primitive;
LAN Type (or Media Type) 1610: 0x01—Ethernet, in one example;
Format 1612: Primitive specific area format. As examples, 0—Existing (original QDIO format; 1—New/modified existing format for EQDIO;
Version 1614: Version number associated with the control primitive header. As examples: 1—QDIO Layer 3 format, 2—QDIO Layer 2 format; 3—EQDIO format;
IP Type 1616: Type of IP address (e.g., IPV4, IPV6);
Assist Option 1618: Identifies IP Assist function associated with the primitive (e.g., 00000001—Offload of ARP and Neighbor Discovery Functions; 00000002—ARP filtering to enable filtering of ARP packets not associated with host subnet/IP addresses; 00000004—Adapter module or network interface card offloads including checksum and segmentation offload options and requirements for IPV4 and IPV6, as examples; 00000008—Filtering for specific Ethernet and IP packet types; 00000010—Sets a global netmask which applies to SetAsstParms subcommands);
Length of Subcommand (Subcmd) Request 1620: Length of the subcommand request;
Subcommand 1622: Subcommand being requested (e.g., 0001 Enable ARP Offload);
Number of Reply Blocks 1624: Total number of reply blocks returned by the adapter module in response to the primitive. This is set to, e.g., 0 in a request primitive;
Block Sequence Number 1626: Sequence number associated with, e.g., the 4K block in the total list of reply blocks, which is set by the adapter module in response to the primitive. This is set to, e.g., 0 in a request primitive.

Returning to FIG. 15, based on receiving initiative, the adapter module (e.g., an adapter module 1550) enables 1552 the address resolution protocol (ARP) offload process and filters address resolution protocol packets from the data plane interface.

In one example, the adapter module (e.g., adapter module 1550) replies 1553 to the Enable_ARP_Offload Request using, for instance, a reply, such as an Enable_ARP_Offload Reply. In one example, as described with reference to FIG. 13, the adapter module stores the reply in a data buffer of the control plane receive queue and updates the control plane adapter queue index on the receive side to indicate where the reply is located.

One example of an Enable_ARP_Offload Reply is described with reference to FIG. 17. In one example, an Enable_ARP_Offload Reply Primitive 1700 includes a plurality of fields, including, for instance:
Command 1702: Command for which this is a reply (e.g., Enable_ARP_Offload);
Initiator 1704: Entity issuing the primitive (e.g., 0x00—Control program initiated; 0x01—Adapter module initiated);
Sequence Number 1706: Value used to match the reply with the request;
Return Code 1708: Return code associated with the primitive. As examples, for this primitive, possible return codes include: 0000—Success; 2001—Failure-Assist already active; 2100—Protocol violation-Interface not in proper state; and 210A—IP Type not supported. Additional, fewer and/or other return codes are possible for this primitive (as well as other primitives);
LAN Type (or Media Type) 1710: 0x01—Ethernet, in one example;
Format 1712: Primitive specific area format. As examples, 0—Existing (original QDIO format; 1—New/modified existing format for EQDIO;
Version 1714: Version number associated with the control primitive header. As examples: 1—QDIO Layer 3 format; 2—QDIO Layer 2 format; 3—EQDIO format
IP Type 1716: Type of IP address (e.g., IPV4, IPV6);
Bit Mask of Supported ARP Offload Options 1717: A mask of supported offload options;
Assist Option 1718: Identifies IP Assist function associated with the primitive (e.g., 00000001—Offload of ARP and Neighbor Discovery Functions; 00000002—ARP filtering to enable filtering of ARP packets not associated with host subnet/IP addresses; 00000004—Adapter module or network interface card offloads including checksum and segmentation offload options and requirements for IPV4 and IPV6, as example; 00000008—Filtering for specific Ethernet and IP packet types; 00000010—Sets a global netmask which applies to SetAsstParms subcommands);
Length of Subcommand Reply 1720: Length of the subcommand reply;
Subcommand 1722: Subcommand for which this is the reply (e.g., 0001 Enable_ARP_Offload);
Number of Reply Blocks 1724: Total number of reply blocks returned by the adapter module in response to the primitive;
Block Sequence Number 1726: Sequence number associated with, e.g., the 4K block in the total list of reply blocks, which is set by the adapter module in response to the primitive.

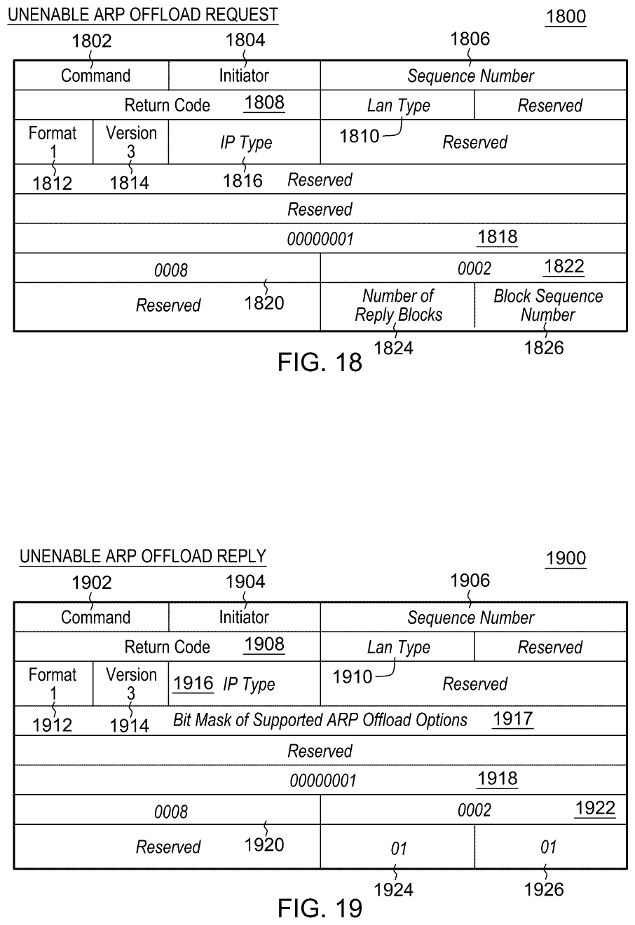

In one example, the enable offload function may be unenabled using, for instance, an Unenable_ARP_Offload Request primitive, an example of which is depicted in FIG. 18. The Unenable_ARP_Offload Request is used to unenable the ARP offload feature for the specific IP type. Based on receiving this subcommand (e.g., 0002) by the adapter module, prior ARP offload active primitives are terminated. In one example, any IP addresses specified with the ARP_SETIP are purged.

Referring to FIG. 18, in one example, an Unenable_ARP_Offload Request primitive 1800 includes a plurality of fields used to provide information relating to the request. A definition of each of the fields is described with reference to FIG. 16, and therefore, is not repeated here. Similar reference numbers correspond to similar fields; e.g., 1602 in FIG. 16 corresponds to 1802 in FIG. 18, etc.

A reply to the Unenable_ARP_Offload Request may be provided from the adapter module to the control program. One example of an Unenable_ARP_Offload Reply is described with reference to FIG. 19. In one example, an Unenable_ARP_Offload Reply 1900 includes a plurality of fields. A definition of each of the fields is described with reference to FIG. 17, and therefore, is not repeated here. Similar reference numbers correspond to similar fields; e.g., 1702 in FIG. 17 corresponds to 1902 in FIG. 19, etc. Examples of return codes that may be returned in the return code field (e.g., field 1908) include, for instance, 0001—Success; 2001—Failure-Assist not active; 2100—Protocol violation-interface not in proper state; and 210A—Invalid IP Type.

Returning to FIG. 15, based on enabling ARP offload, in one example, control program 1500 registers an IP address and subnet for ARP offload processing (e.g., using register address/subnet code 1403) by, for instance, issuing 1506 an ARP_SETIP primitive for a selected IP address (e.g., ARP_SETIP 10.10.1.5). An ARP_SETIP primitive is used to inform the adapter module to perform ARP (for IPV4) or Neighbor Discovery (for IPV6) processing associated with the IP address. This includes duplicate address detection during initialization along with address resolution sequences on the network. The adapter module replies to address resolution protocol requests and neighbor solicitation requests for the specified IP address.

In one example, IP addresses specified in the ARP_SETIP primitive are added to the local address resolution protocol cache and can be removed using, e.g., an ARP_DELIP primitive.

For duplicate address detection, in one example, the adapter module sends out IPV4 gratuitous address resolution protocols and IPV6 duplicate address detection neighbor solicitation packets for each VLAN in the ARP_SETIP request. The source MAC address used for each request is, e.g., the virtual MAC address specified in the primitive.

If, in one example, the “Suppress Duplicate Address Detection” flag is set in the ARP_SETIP primitive, duplicate address detection replies received for the GRAT address resolution protocols are ignored, except for the final GRAT ARP. The final GRAT ARP is determined based on the “Duplicate Address Detection Count” value set by the control program in the Primitive.

On successful completion of the duplicate address detection protocols, the IP address is added to the adapter module's local ARP cache. The adapter module keeps an address resolution protocol cache for IP Addresses registered with the ARP_SETIP.

Based on an ARP_SETIP completing successfully, the adapter module ARP offload function performs, for instance, the following for any received address resolution protocol requests:
Verify the target protocol address in the ARP request matches an IP address registered with the ARP_SETIP.
Generate an Update_ARP_Cache request containing the source protocol address and source hardware address extracted from the ARP request for IPV4 addresses when the target protocol address matches the IP address registered with ARP_SETIP.
ARP requests which do not contain a target protocol address matching an IP address registered with an ARP_SETIP will be dropped.
A Gratuitous ARP received for an IP Address matching a registered IP subnet will be forwarded to the corresponding control programs via the Update_ARP_Cache primitive. This is used, for instance, for guest relocation and Address Resolution Protocol refresh functions.
Any Null Gratuitous ARP received will be forwarded to control programs via the UPDATE_ARP_CACHE primitive which have issued a prior ARP_SETIP.

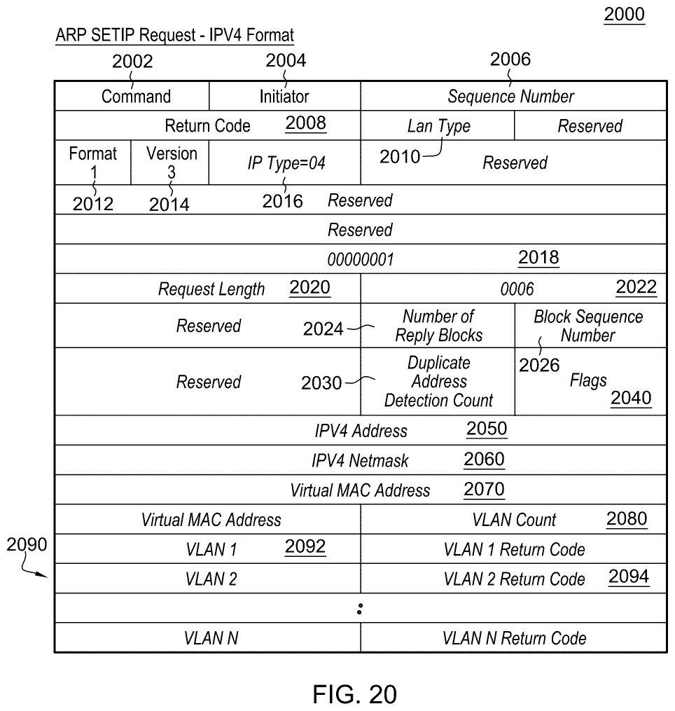

One example of an ARP_SETIP Request is described with reference to FIG. 20. In one example, an ARP_SETIP Request primitive 2000 includes a plurality of fields used to provide information relating to the request. A definition of each of the fields up to and including the block sequence number is described with reference to FIG. 16, and therefore, is not repeated here. Similar reference numbers correspond to similar fields; e.g., 1602 in FIG. 16 corresponds to 2002 in FIG. 20, etc. The values for each of those fields are shown in FIG. 20.

In one example, ARP_SETIP Request primitive 2000 also includes the following fields:
Duplicate Address Detection Count 2030—The number of Address Resolution requests generated to verify no duplicate IP exists.
   DEFAULT=>4
   In one example, a standard sequence of 4 GRAT address resolution protocols transmitted would have the first GRAT ARP sent at Time 0, the second after, e.g., 2 s (seconds), the third after, e.g., 4 s and the final after, e.g., 8 s. The total time in the sequence would be approximately 16 s. This is only one example. Many other examples are possible.
   The minimum value allowed for this value is, e.g., 2. If the control program sets a value of 1, it is ignored, in one example, and 2 GRAT address resolution protocols are generated. Note, if a value of 0 is set, in one example, it will default to four as described above. Other examples are possible.
Flags 2040: Example flags include:
   0x04—Suppress Duplicate Address Detection=>Suppress the failure of an initial duplicate IP. This flag disables the failure of the ARP SETIP if a duplicate IP address detection address resolution protocol reply is received from another station in the network during the initial GRAT address resolution protocol processing. When this flag is set, an initial successful reply is returned, in one example. If a duplicate IP address detection is received during the initial GRAT address resolution protocol sequence, it is ignored in one example. A final GRAT address resolution protocol is sent out based on the “Duplicate Address Detection Count” specified and if there is a duplicate IP address received for this GRAT address resolution protocol, an Update_ARP_Cache primitive is sent with the failure code indicating a duplicate IP was detected for a previous ARP_SETIP. The appropriate flags and return code are set, for instance, in the Update_ARP_Cache to identify the original ARP_SETIP.
   In one example, the Suppress Duplicate Address Detection flag is to resolve the timing issues with Live Guest Migration when the terminating Host has not completed the Guest shutdown when the migrated Guest has completed its initialization.
IPV4 Address 2050: A specified IPV4 address.
IPV4 Netmask 2060: A specified netmask.
Virtual MAC Address 2070: Source MAC Address to be used for ARP packets generated by the network interface card for the registered IPV4 address.
VLAN Count 2080: The number of VLAN IDs associated with the IP address.
   If the Global VLAN ID is set on the interface, this field is N/A, in one example.
VLAN Area 2090: Each entry in area 2090 includes a VLAN ID 2092 (e.g., 2 bytes) and a return code 2094 (e.g., 2 bytes). The return code is valid in a reply.

In one example, a minimum length used for the IPV4 ARP_SETIP request is 52 bytes. When the Global VMAC address flag is set, both the virtual MAC address and VLAN count is set to 0, in one example. When the Global VLAN ID flag is set, the VLAN Count is set to 0, in one example.

In one example, the ARP_SETIP Request primitive 2000 is for an IP Type 4 (e.g., IPV4); however, a similar request primitive may be used for an IP Type 6 (e.g., IPV6). In such an example, the fields are similar to those described with reference to FIG. 20, except that the IP Type is 6; multiple IPV6 Address fields (e.g., IPV6 Address bits 0:31, IPV6 Address bits 32:63, IPV6 Address bits 64:95, IPV6 Address bits 96:127) replace IPV4 Address field 2050; multiple IPV6 Netmask fields (e.g., IPV6 Netmask bits 0:31, IPV6 Netmask bits 32:62, IPV6 Netmask bits 63:95, IPV6 Netmask bits 96:127) replace IPV4 Netmask field 2060. Other examples are possible.

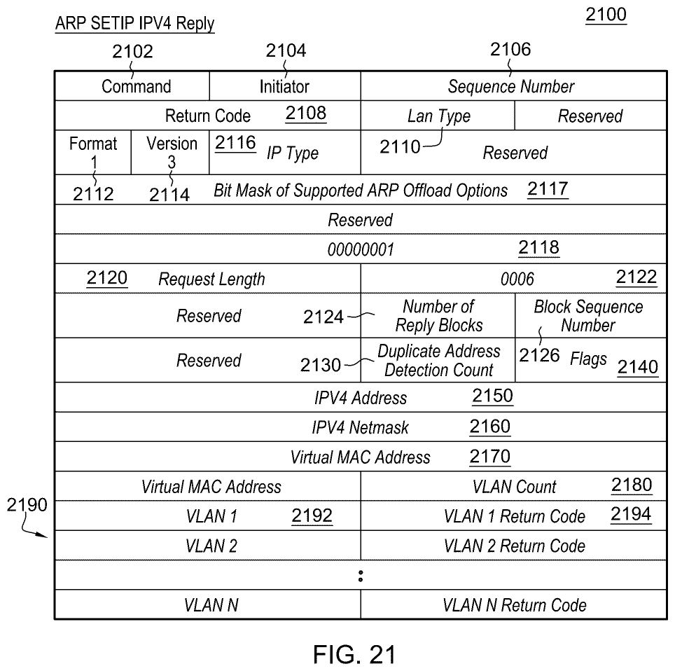

Returning to FIG. 15, based on receiving the ARP_SETIP request, the adapter module performs 1554 duplicate IP address detection and issues a reply on completion. One example of an ARP_SETIP Reply is depicted in FIG. 21. In one example, an ARP_SETIP Reply 2100 includes a plurality of fields. A definition of each of the fields is described with reference to FIG. 20 (and FIG. 17), and therefore, is not repeated here. Similar reference numbers correspond to similar fields; e.g., 2002 in FIG. 20 corresponds to 2102 in FIG. 21, etc. The values for each of the fields are shown in FIG. 21.

Example primitive return codes returned in return code 2108 include, for instance:
0000 Success
2001 Failure—Enable Address Resolution Protocol Offload not issued
200D Virtual MAC Address specified was not previously registered on this
interface 2100 Protocol violation—Interface not in the proper State
210A Invalid IP Type
2015 Invalid VLAN ID
201A One or More Duplicate Address Detections Detected
2089 Invalid VLAN Count
If the Global VMAC or Global VLAN flag is set, the primitive return code contains the specific error code.

Example VLAN “N” return codes returned in VLAN “N” Return Code 2194 include, for instance:
0000 Success
2005 Duplicate IP+VLAN detected
200E IP+VLAN already registered on this interface. The IP+VLAN remains registered and this instance of the primitive has no effect.

If the Global VLAN Flag is set, VLAN 1 Return Code is used.

In one example, the ARP_SETIP Reply primitive 2100 is for an IP Type 4 (e.g., IPV4); however, a similar request primitive may be used for an IP Type 6 (e.g., IPV6). In such an example, the fields are similar to those described with reference to FIG. 21, except that the IP Type is 6; multiple IPV6 Address fields (e.g., IPV6 Address bits 0:31, IPV6 Address bits 32:63, IPV6 Address bits 64:95, IPV6 Address bits 96:127) replace IPV4 Address field 2150; multiple IPV6 Netmask fields (e.g., IPV6 Netmask bits 0:31, IPV6 Netmask bits 32:62, IPV6 Netmask bits 63:95, IPV6 Netmask bits 96:127) replace IPV4 Netmask field 2160. Other examples are possible.

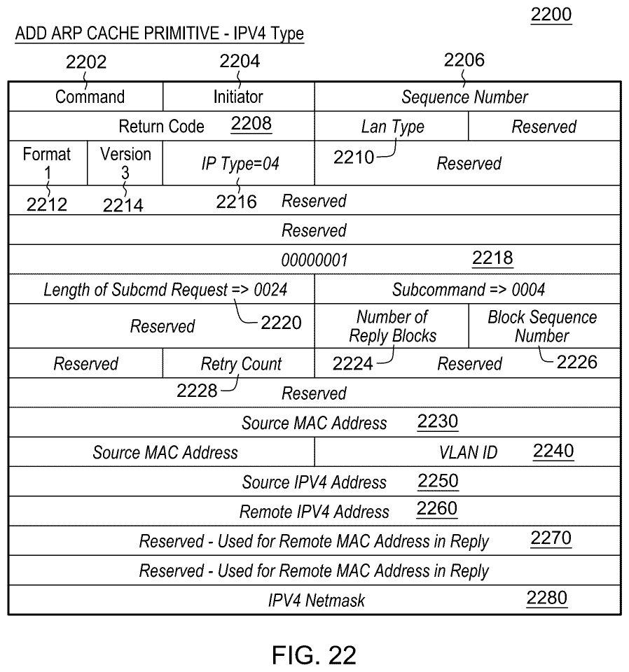

Returning to FIG. 15, based on receiving the reply, in one example, control program 1500 issues an ARP request for a remote IP address (e.g., using issue ARP Request for a Remote IP Address code 1404) by, for instance, issuing 1508 an Add_ARP_Cache Request to resolve an ARP for, e.g., 10.10.1.8. In one example, an Add_ARP_Cache primitive is used by the control program to instruct the adapter module to generate an ARP Request for a remote address (e.g., 10.10.1.8). One example of an Add_ARP_Cache primitive is described with reference to FIG. 22. In one example, an Add_ARP_Cache primitive 2200 is used to generate an ARP Request to the destination address specified in the primitive request.

In one example, an Add_ARP_Cache Request primitive 2200 includes a plurality of fields used to provide information relating to the request. A definition of each of the fields up to and including the block sequence number is described with reference to FIG. 16, and therefore, is not repeated here. Similar reference numbers correspond to similar fields; e.g., 1602 in FIG. 16 corresponds to 2202 in FIG. 22, etc. The values for each of those fields are shown in FIG. 22.

In one example, Add_ARP_Cache Request primitive 2200 also includes the following fields:
Retry Count 2228: Number of attempts to send the Address Resolution Protocol (ARP) Request. The retries are sent, e.g., in increasing increments of 1 s, 2 s, 4 s, 8 s, etc. The default value is, e.g., 4. When an ARP Reply is received, no further ARP Requests are sent. The retry count determines a maximum number of ARP Requests sent with no ARP Reply received.
Source MAC Address 2230: This is the source hardware address used in the ARP Request.
   If the Global VMAC Address is set on this interface, this field is N/A.
VLAN ID 2240:
   If the Global VLAN ID is set on the Interface, this field is N/A.
Source IPV4 Address 2250: This is the source protocol address used in the ARP Request.
Remote IPV4 Address 2260: This is the target protocol address used in the ARP Request.
Reserved—Used for Remote MAC Address on the Reply 2270.
IPV4 Netmask 2280: This field is used to verify the source and remote IPV4 addresses are on the same IP subnet.
   If the Global Netmask is set on the Interface, this field is N/A, in one example.

In one example, the control program is responsible for the ARP cache timeout logic. The adapter module does not maintain an Address Resolution Protocol Cache for Remote IP entries, in one example.

In one example, the Add_ARP_Cache Request primitive 2200 is for an IP Type 4 (e.g., IPV4); however, a similar request primitive may be used for an IP Type 6 (e.g., IPV6). In such an example, the fields are similar to those described with reference to FIG. 22, except that the IP Type is 6; multiple source IPV6 Address fields (e.g., IPV6 Address bits 0:31, IPV6 Address bits 32:63, IPV6 Address bits 64:95, IPV6 Address bits 96:127) replace source IPV4 Address field 2250; multiple destination IPV6 address fields and target address fields replace remote IPV4 address field 2260; multiple IPV6 Netmask fields (e.g., IPV6 Netmask bits 0:31, IPV6 Netmask bits 32:62, IPV6 Netmask bits 63:95, IPV6 Netmask bits 96:127) replace IPV4 Netmask field 2280. Other examples are possible.

Returning to FIG. 15, based on the Add_ARP_Cache request, adapter module 1550 generates an ARP Request for the remote address (e.g., remote IPV4 or IPV6 address) and sends 1558 the ARP Request to, e.g., 10.10.1.8. If an ARP Reply is received from the destination address (e.g., IPV4 or IPV6 address), adapter module 1550 returns 1560 an owning MAC address in an Add_ARP_Cache Reply. In one example, the reply includes the source protocol address and source hardware address in the ARP Reply. The adapter module does not, in one example, maintain an active remote address resolution protocol cache entry for the remote station. It is the control program's responsibility to maintain the remote address resolution protocol cache, in one example.

If the address resolution protocol retries timeout without an address resolution protocol reply being received, the Add_ARP_Cache Reply subcommand is returned, in one example, with the “No Address Resolution Protocol Reply Received” return code (0x2010).

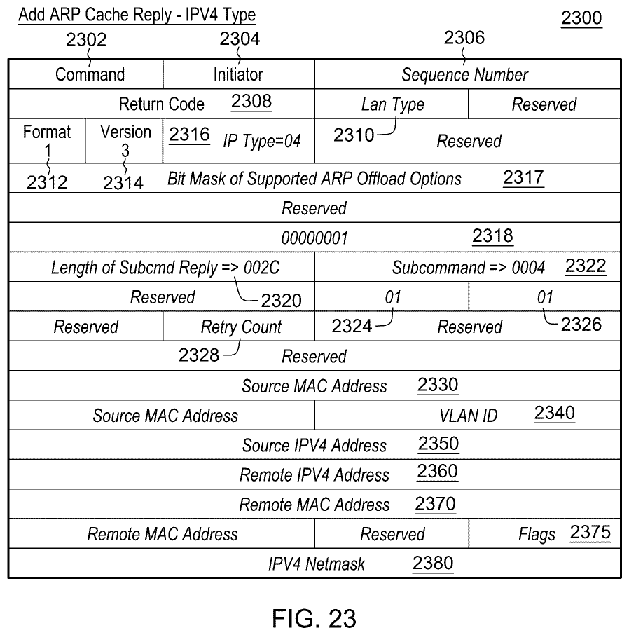

One example of an Add_ARP_Cache Reply primitive for an IPV4 type is described with reference to FIG. 23. In one example, an Add_ARP_Cache Reply primitive 2300 returns, e.g., the MAC address associated with the destination IPV4 Address if an ARP Reply is received. Otherwise, the “No Reply Received” return code is set, in one example.

In one example, an Add_ARP_Cache Reply primitive 2300 includes a plurality of fields used to provide information relating to the reply. A definition of many of the fields is described with reference to FIG. 22 (and FIG. 17), and therefore, is not repeated here. Similar reference numbers correspond to similar fields; e.g., 2202 in FIG. 22 corresponds to 2302 in FIG. 23, etc. The values for each of those fields are shown in FIG. 23.

One or more of the fields of Add_ARP_Cache Reply primitive 2300 are further described below, in one example:
Source MAC Address 2330: Matches the source MAC address specified on the Add_ARP_Cache primitive request. This is, e.g., the target hardware address in the ARP Reply.
VLAN ID 2340: The VLAN ID from the ARP Reply.
Source IPV4 Address 2350: Matches the source IPV4 address specified on the Add_ARP_Cache primitive request. This is, e.g., the target protocol address in the ARP Reply.
Remote IPV4 Address 2360: Matches the remote IPV4 address specified on the Add_ARP_Cache primitive request. This is, e.g., the source protocol address in the ARP Reply.
Remote MAC Address 2370: This is the source hardware address in the ARP Reply.
Flags 2375: As examples:
   0x01—Remote Address
0x02—Remote Address accessible LPAR to LPAR
IPV4 Netmask 2380: This is the IPV4 netmask used to determine the IP subnet, in one example.

In one example, the Add_ARP_Cache Reply primitive 2300 is for an IP Type 4 (e.g., IPV4); however, a similar reply primitive may be used for an IP Type 6 (e.g., IPV6). In such an example, the fields are similar to those described with reference to FIG. 23, except that the IP Type is 6; multiple IPV6 Address fields (e.g., IPV6 Address bits 0:31, IPV6 Address bits 32:63, IPV6 Address bits 64:95, IPV6 Address bits 96:127) replace source IPV4 Address field 2350; multiple destination and target addresses replace remote address 2360; multiple IPV6 Netmask fields (e.g., IPV6 Netmask bits 0:31, IPV6 Netmask bits 32:62, IPV6 Netmask bits 63:95, IPV6 Netmask bits 96:127) replace IPV4 Netmask field 2380. Other examples are possible.

Returning to FIG. 15, based on an Add_ARP_Cache Reply, control program 1500 adds 1510, e.g., 10.10.1.8 to its ARP cache (e.g., in control program memory).

Further, in one example, adapter module 1550 receives 1562 an ARP Request from, e.g., 10.10.1.6 to 10.10.1.5. Based thereon, adapter module 1550 sends an ARP Reply, and further, in one example, sends 1564 an Update_ARP_Cache to the control program for 10.10.1.6.

In one example, an Update_ARP_Cache primitive is used by the adapter module to inform the control program of an address resolution protocol or neighbor solicitation request from a remote IP address which had a target protocol address matching an IP address previously registered with an ARP_SETIP. In one example, an initiator field in the primitive header is set to indicate the primitive is issued by the adapter module. No reply is required by the adapter module, unless an error occurs processing the Update_ARP_Cache request. The adapter module instructs (e.g., using update IP address code 1406) the control program to add an IP address to the ARP cache owned by the control program by, for instance, issuing an Update_ARP_Cache primitive.

In one example, the Update_ARP_Cache subcommand is also used to indicate a duplicate IP address detection for a previously issued ARP_SETIP. For this case, the issued ARP_SETIP had set flags to suppress the initial duplicate IP address detections. This flag causes, for instance, a final GRAT Address Resolution Protocol request to be sent out based on the “Duplicate Address Detection Count”. In one example, if a duplicate address detection address resolution protocol reply is received to the final GRAT Address Resolution Protocol, the Update_ARP_Cache primitive is generated to indicate the duplicate address condition.

In one example, the adapter module attempts to forward ARP Requests received from the network to the appropriate control programs. However, since the ARP Requests generate unsolicited traffic on the receive control queue, it is possible the control program may not have sufficient buffer space available to handle all the unsolicited address resolution protocol requests. The adapter module attempts to not drop any ARP Requests which are associated with address changes/updates in the network. These include, for instance, GRAT Address Resolution Protocols, Null GRAT Address Resolution Protocols and Address Resolution Protocol Requests with a source protocol Address and a Null source hardware address. Other ARP Requests could be dropped if there are no receive buffers available on the receive control queue when the ARP Request is received and the adapter module pending queue for the specific EQDIO interface is full. Other examples are possible.

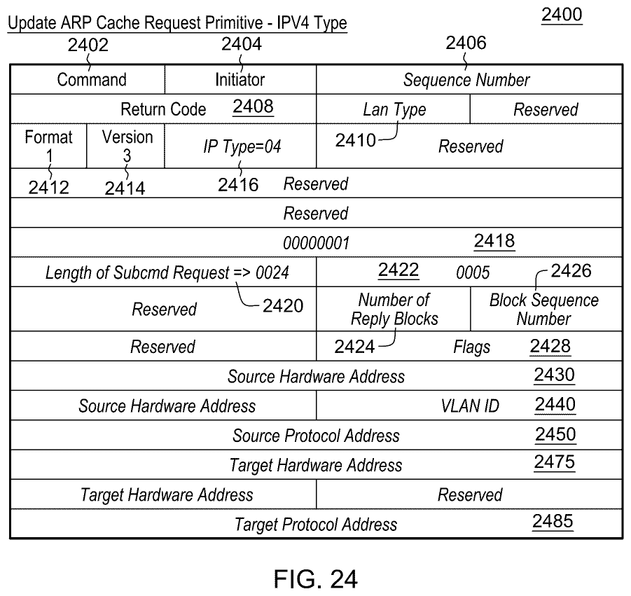

One example of an Update_ARP_Cache primitive is described with reference to FIG. 24. In one example, an Update_ARP_Cache primitive 2400 is used to inform the control program of an ARP Request from a remote station. The ARP Request is to have the target protocol address (IP Address) of an IP Address registered with the ARP_SETIP primitive.

In one example, an Update_ARP_Cache Request primitive 2400 includes a plurality of fields used to provide information relating to the request. A definition of each of the fields up to and including the block sequence number is described with reference to FIG. 16, and is therefore, not repeated here. Similar reference numbers correspond to similar fields; e.g., 1602 in FIG. 16 corresponds to 2402 in FIG. 24, etc. The values for each of those fields are shown in FIG. 24.

In one example, Update_ARP_Cache Request primitive 2400 also includes the following fields:
Flags 2428: As examples:
   0x0001—Update is from an ARP Request. The target protocol address matches an IP Address specified on an ARP_SETIP.
   0x0002—Update is from a GRAT ARP Request. The protocol address' IP subnet matches the IP subnet specified on an ARP_SETIP.
   0x0004—Update is from a NULL GRAT ARP.
   0x8000—Update is for a previous ARP_SETIP which has seen a duplicate IP response after the final GRAT ARP sent, e.g., 30 s after the initial ARP_SETIP.
Source Hardware Address 2430: The source hardware address from the ARP Request packet. This is the MAC Address of the remote station.
VLAN ID 2440: The VLAN ID in the ARP Request.
Source Protocol Address 2450: The source protocol address from the ARP Request packet. This is the IPV4 address of the remote station.
Target Hardware Address 2475: The target hardware address from the ARP Request packet. This is the MAC Address associated with the control program interface.
Target Protocol Address 2485: The target protocol address from the ARP Request packet. This is the IPV4 Address associated with the control program interface.

In one example, the Update_ARP_Cache Request primitive 2400 is for an IP Type 4 (e.g., IPV4); however, a similar request primitive may be used for an IP Type 6 (e.g., IPV6). In such an example, the fields are similar to those described with reference to FIG. 24, except that the IP Type is 6; and multiple IPV6 address fields for a particular address field may be used. Other examples are possible.

Returning to FIG. 15, based on receiving the Update_ARP_Cache from adapter module 1550, control program 1500 adds (1514) 10.10.1.6 to its ARP cache.

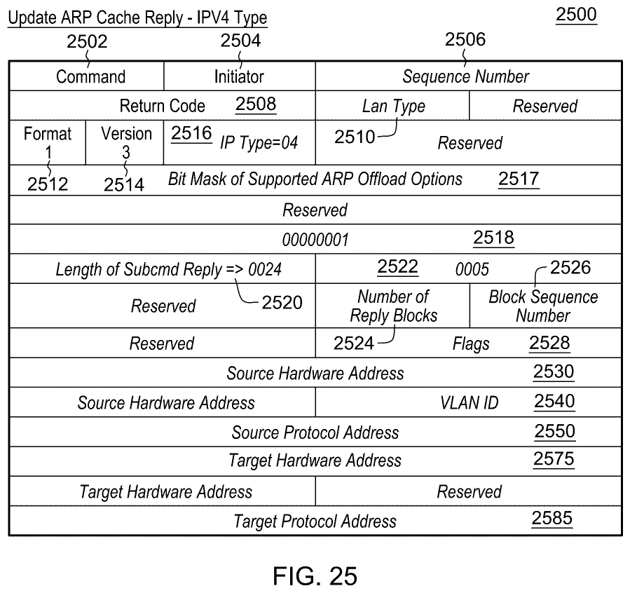

In one example, if the Update_ARP_Cache contains invalid data when parsed by the control program, an Update_ARP_Cache Reply is provided. An Update_ARP_Cache Reply reflects back the original request contents with the associated primitive and subcommand return code fields set. One example of an Update_ARP_Cache Reply is depicted in FIG. 25. In one example, an Update_ARP_Cache Reply 2500 includes a plurality of fields. A definition of each of the fields is described with reference to FIG. 24, and therefore, is not repeated here. The values for each of those fields are shown in FIG. 25.

In one example, Update_ARP_Cache Reply primitive 2500 also includes, for instance, a Bit Mask of Supported ARP Offload Options 2517: A mask of supported offload options.

Further, in one example, return code field 2508 is set to one of the following, as examples: 0000 Success; 2002 Initiator was not an Open Systems Adapter; 2017 Invalid primitive parameter; and 210A Invalid IP type. Additional, fewer and/or other return codes may be used.

In one example, the Update_ARP_Cache Reply primitive 2500 is for an IP Type 4 (e.g., IPV4); however, a similar request primitive may be used for an IP Type 6 (e.g., IPV6). In such an example, the fields are similar to those described with reference to FIG. 25, except that the IP Type is 6; and multiple IPV6 address fields for a particular address field may be used. Other examples are possible.

Returning to FIG. 15, in one or more aspects, adapter module 1550 receives 1568 a GRAT ARP for a selected address (e.g., 10.10.1.6), and in one example, sends 1570 a GRAT ARP to control program 1500 via, e.g., an Update_ARP_Cache Request to update the ARP cache (e.g., the control program's ARP cache) for the selected address (e.g., 10.10.1.6). In one example, GRAT ARP requests that match the IP subnet of an ARP offload enabled interface are forwarded to these control programs using the Update_ARP_Cache primitive. The GRAT ARP is used to update the MAC address in the ARP cache entry for the corresponding source IP address in the GRAT ARP.

Based on receiving the GRAT ARP, control program 1500 updates 1516 the ARP cache entry for the selected address (e.g., 10.10.1.6) with, e.g., a new MAC address.

In one or more aspects, adapter module 1550 receives 1574 a Null GRAT ARP and sends 1576 the Null GRAT ARP to the ARP offload registered control programs in, e.g., an Update_ARP_Cache primitive. In one example, Null GRAT ARP requests received by the adapter module are forwarded to ARP offload active interfaces with a registered IP Address using, e.g., the Update_ARP_Cache primitive. The Null GRAT ARP is used, for instance, to clear ARP cache entries which contain the MAC Address present in the Null GRAT ARP.

Based on receiving the Null GRAT ARP, control program 1500 purges 1520 the ARP cache for 10.10.1.8 which contains a matching MAC address in the Null GRAT ARP.

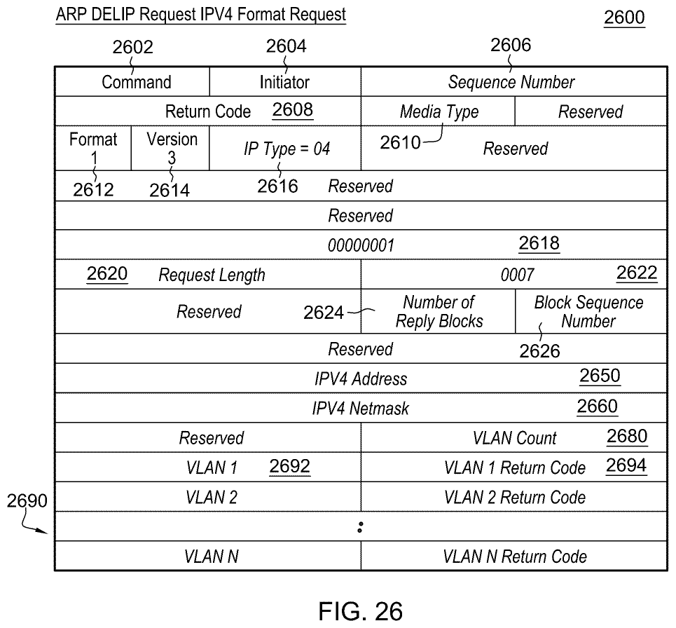

In one or more aspects, to remove address resolution protocol (for IPV4) or neighbor discovery (for IPV6) ARP Offload processing, the adapter module (e.g., using unregister address/subnet code 1408) uses, for instance, an ARP_DELIP primitive to remove the offload processing. The request may specify multiple VLAN IDs associated with the IP address. One example of an ARP_DELIP Request is described with reference to FIG. 26. In one example, an ARP_DELIP Request primitive 2600 includes a plurality of fields used to provide information relating to the request. A definition of each of the fields is described with reference to FIGS. 16 and 20, and is therefore, not repeated here. Similar reference numbers correspond to similar fields; e.g., 2002 in FIG. 20 corresponds to 2602 in FIG. 26, etc.

In one example, the ARP_DELIP Request primitive 2600 is for an IP Type 4 (e.g., IPV4); however, a similar request primitive may be used for an IP Type 6 (e.g., IPV6). In such an example, the fields are similar to those described with reference to FIG. 26, except that the IP Type is 6; multiple IPV6 Address fields (e.g., IPV6 Address bits 0:31, IPV6 Address bits 32:63, IPV6 Address bits 64:95, IPV6 Address bits 96:127) replace IPV4 Address field 2650; multiple IPV6 Netmask fields (e.g., IPV6 Netmask bits 0:31, IPV6 Netmask bits 32:62, IPV6 Netmask bits 63:95, IPV6 Netmask bits 96:127) replace IPV4 Netmask field 2660. Other examples are possible.

In one example, the one or more VLANs are to be associated with the IP address, and the VLAN ID (e.g., 2692) is to have been previously specified by an ARP_SETIP primitive. Other examples are possible.

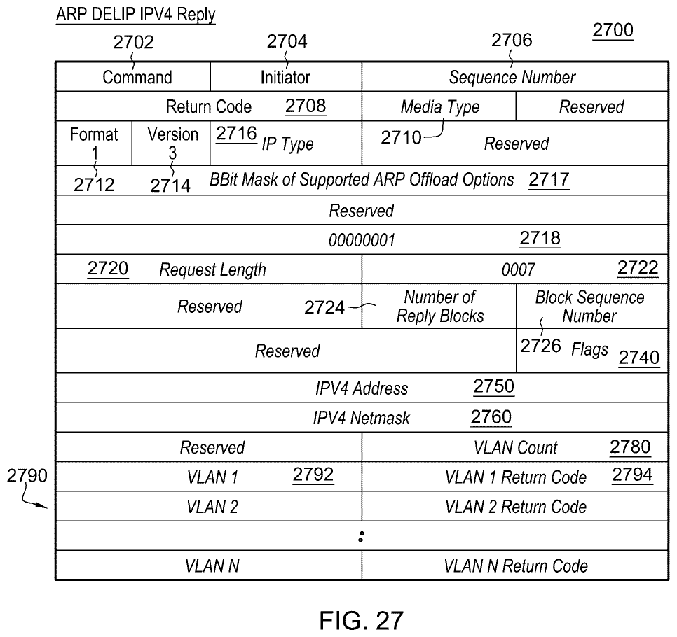

In response to an ARP_DELIP Request, an ARP_DELIP Reply may be sent. One example of an ARP_DELIP Reply is described with reference to FIG. 27. In one example, an ARP_DELIP Reply primitive 2700 includes a plurality of fields used to provide information relating to the reply. A definition of each of the fields is described with reference to FIGS. 16 and 21, and is therefore, not repeated here. Similar reference numbers correspond to similar fields; e.g., 2102 in FIG. 21 corresponds to 2702 in FIG. 27, etc.

In one example, the ARP_DELIP Reply primitive 2700 is for an IP Type 4 (e.g., IPV4); however, a similar request primitive may be used for an IP Type 6 (e.g., IPV6). In such an example, the fields are similar to those described with reference to FIG. 27, except that the IP Type is 6; multiple IPV6 Address fields (e.g., IPV6 Address bits 0:31, IPV6 Address bits 32:63, IPV6 Address bits 64:95, IPV6 Address bits 96:127) replace IPV4 Address field 2750; and multiple IPV6 Netmask fields (e.g., IPV6 Netmask bits 0:31, IPV6 Netmask bits 32:62, IPV6 Netmask bits 63:95, IPV6 Netmask bits 96:127) replace IPV4 Netmask field 2760. Other examples are possible.

Example primitive return codes returned in return code 2708 include, for instance:
0000 Success
2001 Failure—Enable Address Resolution Protocol Offload not issued
2100 Protocol violation—Interface not in the proper State
210A Invalid IP Type
201A One or more IP Addresses not found
2089 Invalid VLAN Count
If the Global VMAC or Global VLAN flag is set, the primitive return code contains the specific error code.

Example VLAN “N” return codes returned in VLAN “N” Return Code 2794 include, for instance:
0000 Success
200F IP+VLAN Entry not found

If the Global VLAN Flag is set, VLAN 1 Return Code is used, in one example.

In one or more aspects, ARP filter functionality may be provided that enables the control program to retain ARP ownership but designate an address (e.g., IPV4 address) of an IP subnet. In one example, an Add_ARP_Filter Primitive is used to filter ARP Request/Replies and IPV6 Neighbor Solicitation and Neighbor Advertisement packets received on the LAN for IP addresses and/or IP subnets not associated with an interface. The primitive is designed to give interfaces the capability to still perform address resolution protocol and neighbor discovery functionality but filter address resolution protocols and Neighbor Discovery packets which contain IP addresses and/or IP subnets not associated with an interface.

The ARP filter function is provided to enable a control program to continue to provide the standard address resolution protocol support and use the adapter module logic to filter unwanted address resolution protocol packets from the control program. This feature provides an ARP Assist feature without requiring a re-write of the address resolution protocol packet processing logic in the control program.

When the ARP filter function is used, address resolution protocol packets will still flow on the data plane. The filter function allows address resolution protocol packets matching the filter criteria to passthrough.

For example, if the Add_ARP_Filter specified an IP Subnet of 9.12.16.0, the adapter module allows address resolution protocol packets with a destination protocol address which was on the same 9.12.16.0 IP Subnet. Other address resolution protocol requests would be filtered. This enables an IP interface to continue to perform address resolution protocol processing, but the adapter module to filter address resolution protocol requests which would normally be dropped on the interface.

Any number of IP addresses and IP subnet IDs can be added to the address resolution protocol filter, but each is to be specified in a separate Add_ARP_Filter Primitive, in one example. In one example, any Null GRAT ARP requests received on the interface are not filtered, as those are used to purge ARP cache entries which contain, e.g., the MAC address in the Null GRAT ARP packet.

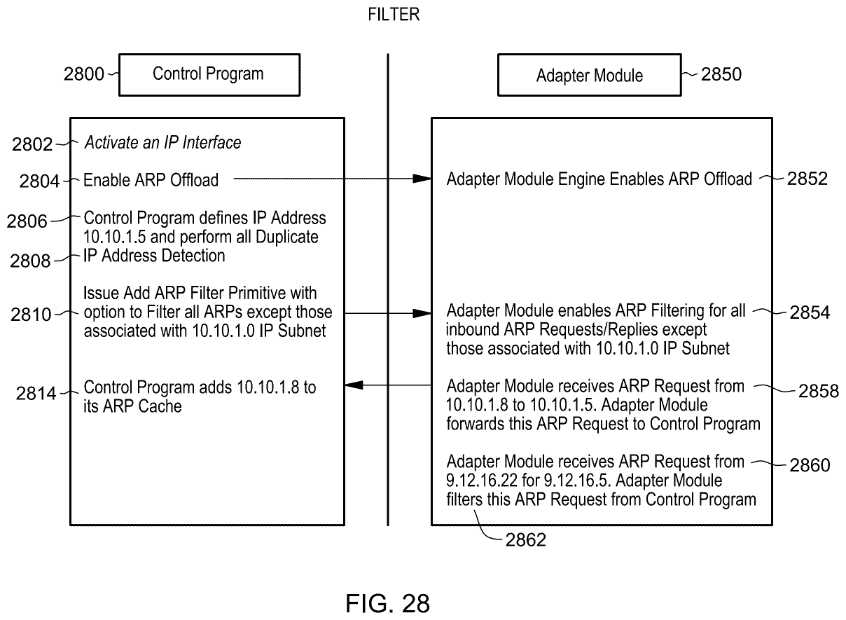

One example of a flow of a control program employing the adapter module to filter address resolution protocols not associated with its home IP subnet is depicted in FIG. 28. In one example, a control program 2800 activates 2802 an IP interface and enables 2804 ARP Offload, examples of which are described herein. Similarly, an adapter module 2850 enables 2852 ARP Offload, as described herein.

In one example, control program 2800 defines 2806 an IP address, e.g., 10.10.1.5 and performs 2808 duplicate IP address detection. Further, in one example, control program 2800 indicates that filtering is performed (e.g., using add ARP filter code 1412) by, for instance, issuing 2810 an Add_ARP_Filter primitive with an option to filter all ARPs except those associated with, e.g., the 10.10.1.0 IP subnet.

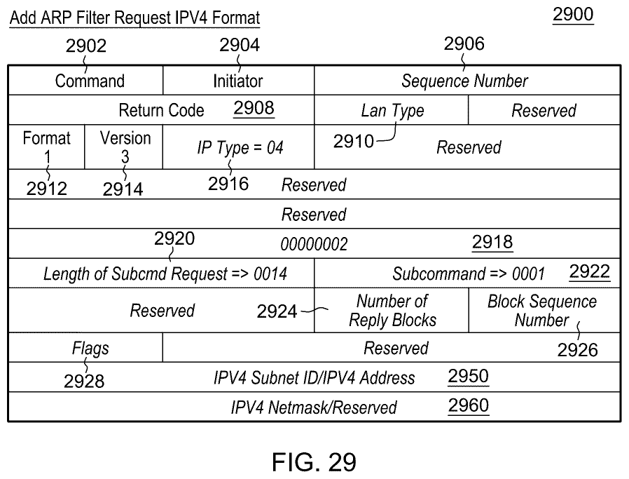

One example of an Add_ARP_Filter Request Primitive is described with reference to FIG. 29. In one example, an Add_ARP_Filter Request primitive 2900 includes a plurality of fields used to provide information relating to the request. A definition of each of the fields up to and including the block sequence number is described with reference to FIG. 16, and therefore, is not repeated here. Similar reference numbers correspond to similar fields; e.g., 1602 in FIG. 16 corresponds to 2902 in FIG. 29, etc. The values for each of those fields are shown in FIG. 29. In one example, the Number of Reply Blocks 2924 and the Block Sequence Number 2926 are not applicable, in one example.

In one example, Add_ARP_Filter Request primitive 2900 also includes the following fields:
Flags 2928: Examples include, for instance:
   0x01—Filter all ARPs except those with a destination protocol address matching the specified IP Address.
      Note, in one example, this will filter all GRAT ARPs from other stations on the same Subnet ID unless the 0x02 flag is also set.
   0x02—Filter all ARPs except those with the destination protocol address matching the specified IP Address and also allow GRAT ARPs received on the same Subnet ID.
   0x04—Filter all ARPs except those associated with the specified Subnet ID.
   0x08—Filter All ARPs/Neighbor Discovery packets.
IP Subnet ID 2950: Applicable when Flags=0x04, in one example.
IP Netmask 2960: Applicable when Flags=0x02 or 0x04, in one example.

In one example, the Add_ARP_Filter Request primitive 2900 is for an IP Type 4 (e.g., IPV4); however, a similar request primitive may be used for an IP Type 6 (e.g., IPV6). In such an example, the fields are similar to those described with reference to FIG. 29, except that the IP Type is 6; multiple IPV6 Subnet/Address fields (e.g., IPV6 Subnet/Address bits 0:31, IPV6 Subnet/Address bits 32:63, IPV6 Subnet/Address bits 64:95, IPV6 Subnet/Address bits 96:127) replace IPV4 Subnet/Address field 2950; and multiple IPV6 Netmask/Reserved fields (e.g., IPV6 Netmask/Reserved bits 0:31/Reserved, IPV6 Netmask/Reserved bits 32:62/Reserved, IPV6 Netmask bits 63:95/Reserved, IPV6 Netmask bits 96:127/Reserved) replace IPV4 Netmask/Reserved field 2960. Other examples are possible.

Returning to FIG. 28, based on receiving the Add_ARP_Filter Request, adapter module 2850 enables 2854 ARP Filtering for all inbound ARP Requests/Replies except those associated with the 10.10.1.0 IP subnet.

In one example, adapter module 2850 receives 2858 an ARP Request from an address, e.g., 10.10.1.8 to, e.g., 10.10.1.5 and forwards this ARP Request to the control program. Based thereon, control program 2800 adds 2814 address 10.10.1.8 to its ARP cache.

In one example, adapter module 2850 receives 2860 an ARP Request from an address, e.g., 9.12.16.22 to, e.g. 9.12.16.5. Adapter module 2850 filters 2862 this ARP Request from the control program. Other examples are possible.

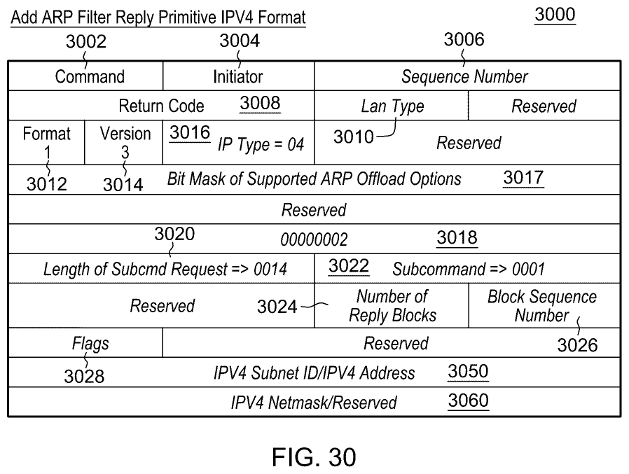

In addition to an Add_ARP_Filter Request, another primitive that may be used is an Add_ARP_Filter Reply that indicates the success or failure of applying the specified ARP Filter. One example of an Add_ARP_Filter Reply is described with reference to FIG. 30. In one example, an Add_ARP_Filter Reply primitive 3000 includes a plurality of fields used to provide information relating to the reply. A definition of each of the fields is described with reference to FIG. 29 (and FIG. 17), and therefore, is not repeated here. The values for each of those fields are shown in FIG. 30.

Example return codes returned in return code 3008 include, for instance, 0000—Success; 0001—Invalid Subnet ID; 2100—Protocol violation-interface not in proper state; 210A—Invalid IP Type. Additional, fewer and/or other return codes and/or return code values may be used.

In one example, the Add_ARP_Filter Reply primitive 3000 is for an IP Type 4 (e.g., IPV4); however, a similar request primitive may be used for an IP Type 6 (e.g., IPV6). In such an example, the fields are similar to those described with reference to FIG. 30, except that the IP Type is 6; multiple IPV6 Subnet/Address fields (e.g., IPV6 Subnet/Address bits 0:31, IPV6 Subnet/Address bits 32:63, IPV6 Subnet/Address bits 64:95, IPV6 Subnet/Address bits 96:127) replace IPV4 Subnet/Address field 3050; and multiple IPV6 Netmask/Reserved fields (e.g., IPV6 Netmask/Reserved bits 0:31/Reserved, IPV6 Netmask/Reserved bits 32:62/Reserved, IPV6 Netmask/Reserved bits 63:95/Reserved, IPV6 Netmask/Reserved bits 96:127/Reserved) replace IPV4 Netmask/Reserved field 3060. Other examples are possible.

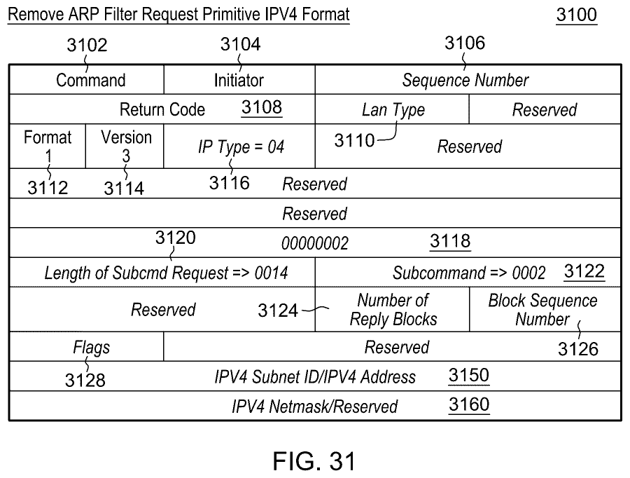

Further, in one example, the control program may remove a filter (e.g., using remove ARP filter code 1414) by, e.g., issuing a Remove_ARP_Filter Request primitive to remove active ARP and IPV6 Neighbor Discovery Filters. As examples, a single IP address, subnet ID or all active ARP Filters can be removed using the primitive. An example of a Remove ARP Filter Request is described with reference to FIG. 31. In one example, a Remove_ARP_Filter Request primitive 3100 includes a plurality of fields used to provide information relating to the request. A definition of each of the fields up to and including the block sequence number is described with reference to FIG. 29 (and FIG. 16), and therefore, is not repeated here. The values for each of those fields are shown in FIG. 31. The Number of Reply Blocks 3124 and the Block Sequence Number 3126 are not applicable, in one example. In one example, Remove_ARP_Filter Request primitive 3100 also includes the following fields:
Flags 3128:
   0x01—Remove the specific ARP Filter associated with the specified IP Address
   0x04—Remove the specific ARP Filter associated with the specified Subnet ID
   0x80—Remove all active ARP Filters
IP Subnet ID/Address 3150: N/A when Flags=0x80, in one example.
IP Netmask/Reserved 3160: Applicable when Flags=0x01, in one example.

In one example, the Remove_ARP_Filter Request primitive 3100 is for an IP Type 4 (e.g., IPV4); however, a similar request primitive may be used for an IP Type 6 (e.g., IPV6). In such an example, the fields are similar to those described with reference to FIG. 31, except that the IP Type is 6; multiple IPV6 Subnet/Address fields (e.g., IPV6 Address/Reserved bits 0:31, IPV6 Subnet/Address bits 32:63, IPV6 Subnet/Address bits 64:95, IPV6 Subnet/Address bits 96:127) replace IPV4 Subnet/Address field 3150; and multiple IPV6 Netmask/Reserved fields (e.g., IPV6 Netmask/Reserved bits 0:31/Reserved, IPV6 Netmask/Reserved bits 32:62/Reserved, IPV6 Netmask bits 63:95/Reserved, IPV6 Netmask bits 96:127/Reserved) replace IPV4 Netmask/Reserved field 3160. Other examples are possible.

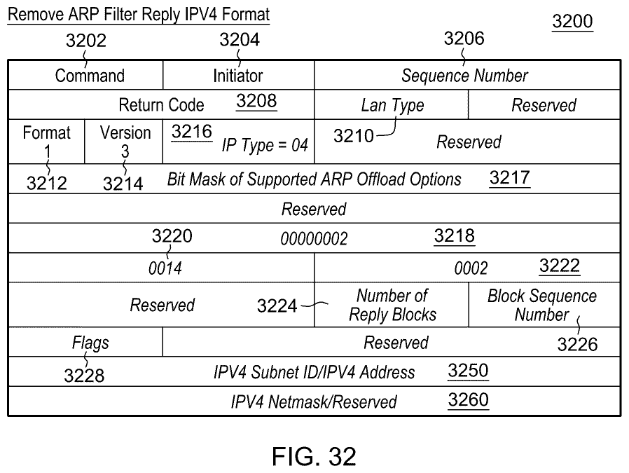

In one example, the success or failure of the removal of the specified ARP Filters may be indicated by a Remove_ARP_Filter Reply. One example of a Remove_ARP_Filter Reply is described with reference to FIG. 32. In one example, a Remove_ARP_Filter Reply primitive 3200 includes a plurality of fields used to provide information relating to the reply. A definition of each of the fields is described with reference to FIG. 31, and therefore, is not repeated here. The values for each of those fields are shown in FIG. 32.

Example return codes returned in return code 3208 include, for instance, 0000—Success; 0001—Invalid Subnet ID; 200F—ARP Filter not found; 2100—Protocol violation-interface not in proper state; 210A—Invalid IP Type. Additional, fewer and/or other return codes and/or return code values may be used.

In one example, the Remove_ARP_Filter Reply primitive 3200 is for an IP Type 4 (e.g., IPV4); however, a similar request primitive may be used for an IP Type 6 (e.g., IPV6). In such an example, the fields are similar to those described with reference to FIG. 32, except that the IP Type is 6; multiple IPV6 Subnet/Address fields (e.g., IPV6 Subnet/Address bits 0:31, IPV6 Subnet/Address bits 32:63, IPV6 Subnet/Address bits 64:95, IPV6 Subnet/Address bits 96:127) replace IPV4 Subnet/Address field 3250; and multiple IPV6 Netmask/Reserved fields (e.g., IPV6 Netmask/Reserved bits 0:31/Reserved, IPV6 Netmask/Reserved bits 32:62/Reserved, IPV6 Netmask/Reserved bits 63:95/Reserved, IPV6 Netmask/Reserved bits 96:127/Reserved) replace IPV4 Netmask/Reserved field 3260. Other examples are possible.

In one or more aspects:

ARP Offload enables the configuration of Offload and Non-Offload EQDIO interfaces to the same network interface card. This feature enables the control programs who have made the changes to support address resolution protocol Offload to share the same network interface card with control programs who have not made these changes.

For broadcast address resolution protocol packets, the adapter module forwards these packets to the (e.g., all) EQDIO interfaces configured with ARP Offload Unenabled, then for all control programs configured with address resolution protocol Offload Enabled, it will only, in one example, reply for the EQDIO interface which has registered the proper IP Address.

For Gratuitous address resolution protocol requests, the adapter module forwards these packets to the (e.g., all) EQDIO interfaces configured with ARP Offload Unenabled, then for all control program configured with address resolution protocol Offload Enabled, it will only, in one example, forward these address resolution protocol requests to interfaces configured with the proper IP subnet.

The adapter module defines a special receive queue and then programs the network interface card to forward all address resolution protocol packets to this queue. The adapter module programs the network adapter to forward the same address resolution protocol packets simultaneously also to (e.g., all) EQDIO interfaces configured with ARP Offload Unenabled.

Address resolution protocol filtering enables a control program to filter address resolution protocols on different IP subnets without affecting IP stack functionality. This function allows a control program to use this feature without requiring any address resolution protocol functional changes in the control program code.

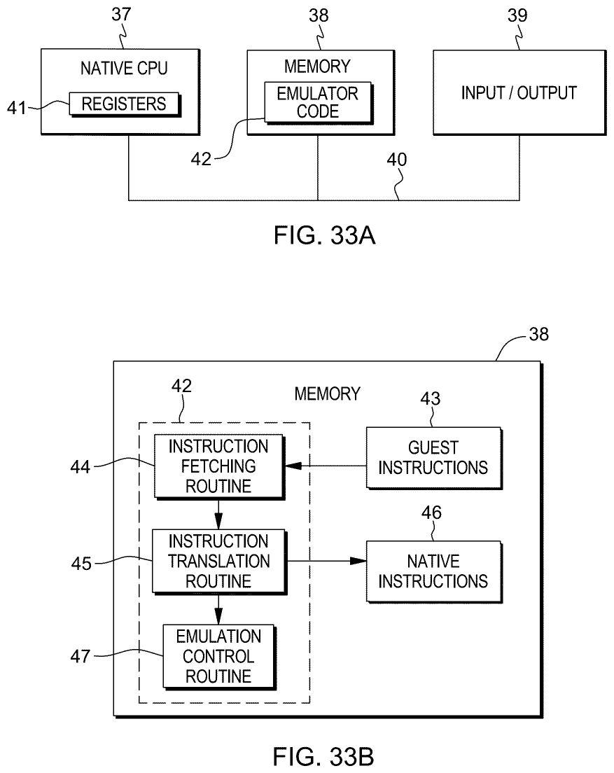

Although one or more examples of a computing environment to incorporate and use one or more aspects of the present disclosure are described herein, FIGS. 33A-33B depict another embodiment of a computing environment to incorporate and use one or more aspects of the present disclosure.

Referring, initially, to FIG. 33A, in this example, a computing environment 36 includes, for instance, a native central processing unit (CPU) 37 based on one architecture having one instruction set architecture, a memory 38, and one or more input/output devices and/or interfaces 39 coupled to one another via, for example, one or more buses 40 and/or other connections.

Native central processing unit 37 includes one or more native registers 41, such as one or more general purpose registers and/or one or more special purpose registers used during processing within the environment. These registers include information that represents the state of the environment at any particular point in time.

Moreover, native central processing unit 37 executes instructions and code that are stored in memory 38. In one particular example, the central processing unit executes emulator code 42 stored in memory 38. This code enables the computing environment configured in one architecture to emulate another architecture (different from the one architecture) and to execute software and instructions developed based on the other architecture.

Further details relating to emulator code 42 are described with reference to FIG. 33B. Guest instructions 43 stored in memory 38 comprise software instructions (e.g., correlating to machine instructions) that were developed to be executed in an architecture other than that of native CPU 37. For example, guest instructions 43 may have been designed to execute on a processor based on the other instruction set architecture, but instead, are being emulated on native central processing unit 37, which may be, for example, the one instruction set architecture. In one example, emulator code 42 includes an instruction fetching routine 44 to obtain one or more guest instructions 43 from memory 38, and to optionally provide local buffering for the instructions obtained. It also includes an instruction translation routine 45 to determine the type of guest instruction that has been obtained and to translate the guest instruction into one or more corresponding native instructions 46. This translation includes, for instance, identifying the function to be performed by the guest instruction and choosing the native instruction(s) to perform that function.

Further, emulator code 42 includes an emulation control routine 47 to cause the native instructions to be executed. Emulation control routine 47 may cause native central processing unit 37 to execute a routine of native instructions that emulate one or more previously obtained guest instructions and, at the conclusion of such execution, return control to the instruction fetch routine to emulate the obtaining of the next guest instruction or a group of guest instructions. Execution of the native instructions 46 may include loading data into a register from memory 38; storing data back to memory from a register; or performing some type of arithmetic or logic operation, as determined by the translation routine.

Each routine is, for instance, implemented in software, which is stored in memory and executed by native central processing unit 37. In other examples, one or more of the routines or operations are implemented in firmware, hardware, software or some combination thereof. The registers of the emulated processor may be emulated using registers 41 of the native central processing unit or by using locations in memory 38. In embodiments, guest instructions 43, native instructions 46 and emulator code 42 may reside in the same memory or may be disbursed among different memory devices.

An example instruction that may be emulated is an instruction used in EQDIO processing described herein (e.g., Set Control Program Queue Controls instruction, Extract Control Program Queue Controls instruction, Store Adapter Indices instruction, other instructions). Further, other EQDIO processing may be emulated and/or ARP processing, including ARP offload and/or filtering, in accordance with one or more aspects of the present disclosure.

The computing environments described herein are only examples of computing environments that can be used. One or more aspects of the present disclosure may be used with many types of environments. The computing environments provided herein are only examples. Each computing environment is capable of being configured to include one or more aspects of the present disclosure. For instance, each may be configured to implement EQDIO processing, ARP processing and/or to perform one or more other aspects of the present disclosure.

One or more aspects of the present disclosure are tied to computer technology and facilitate processing within a computer, improving performance thereof. For instance, communication, including ARP processing, is facilitated using, for instance, an adapter module and control queues. Using the adapter module and/or control queues improves performance and reduces latency.

Other aspects, variations and/or embodiments are possible.

In addition to the above, one or more aspects may be provided, offered, deployed, managed, serviced, etc. by a service provider who offers management of customer environments. For instance, the service provider can create, maintain, support, etc. computer code and/or a computer infrastructure that performs one or more aspects for one or more customers. In return, the service provider may receive payment from the customer under a subscription and/or fee agreement, as examples. Additionally, or alternatively, the service provider may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer-readable code into a computing system, in which the code in combination with the computing system is capable of performing one or more embodiments.

Yet a further aspect, a process for integrating computing infrastructure comprising integrating computer-readable code into a computer system may be provided. The computer system comprises a computer-readable medium, in which the computer medium comprises one or more embodiments. The code in combination with the computer system is capable of performing one or more embodiments.

Although various embodiments are described above, these are only examples. For example, other instructions, instruction formats, operands and/or registers may be used. Further, other types of packets may be received. Moreover, additional, less and/or other code may be used. Although particular code may be provided as an example of performing a particular operation or task, additional and/or other code may be used. Code may be combined and/or separated into code subsets. Many variations are possible.

Various aspects and embodiments are described herein. Further, many variations are possible without departing from a spirit of aspects of the present disclosure. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method comprising:
transmitting, by a control program executing on a computing device of a computing environment to an adapter module executing within the computing environment, control request information, the transmitting using a control plane transmit queue of a set of queues, the control plane transmit queue identifying a location to store the control request information to be retrieved by the adapter module;
receiving, by the control program from the adapter module, an indication of another location storing control reply information replying to the control request information, the indication obtained from a control plane receive queue of the set of queues;
retrieving, by the control program from the another location, the control reply information; and
performing processing, by the control program, based on the control reply information.

2. The computer-implemented method of claim 1, wherein the control request information comprises an address resolution protocol request.

3. The computer program product of claim 2, wherein the address resolution protocol request is an address resolution protocol offload request.

4. The computer program product of claim 3, wherein the address resolution protocol offload request is one address resolution protocol offload request selected from a plurality of address resolution protocol offload requests including an enable offload request to enable address resolution protocol offload processing, a set request to register an address for address resolution protocol offload processing, and an add cache request to request address resolution protocol processing for an address.

5. The computer program product of claim 2, wherein the address resolution protocol request is an address resolution protocol filter request to be used to filter address resolution protocol requests.

6. The computer program product of claim 1, wherein the transmitting the control request information includes updating a control block to indicate the location in which the control request information is stored.

7. The computer program product of claim 1, wherein the transmitting the control request information comprises giving initiative to the adapter module to process the control request information.

8. The computer program product of claim 1, wherein the receiving the indication of the another location storing the control reply information includes accessing a control block of the control plane receive queue to obtain the another location.

9. The computer program product of claim 1, wherein the control request information includes an address of one type and the control reply information includes another address of another type, the other address of the other type corresponding to the address of the one type.

10. The computer program product of claim 9, wherein the control program adds the another address to an address resolution protocol cache of the control program.

11. A computer system comprising:
at least one computing device;
a set of one or more computer-readable storage media; and
program instructions, collectively stored in the set of one or more computer-readable storage media, for causing the at least one computing device to perform computer operations including:
transmitting, by a control program executing on a computing device of a computing environment to an adapter module executing within the computing environment, control request information, the transmitting using a control plane transmit queue of a set of queues, the control plane transmit queue identifying a location to store the control request information to be retrieved by the adapter module;
receiving, by the control program from the adapter module, an indication of another location storing control reply information replying to the control request information, the indication obtained from a control plane receive queue of the set of queues;
retrieving, by the control program from the another location, the control reply information; and
performing processing, by the control program, based on the control reply information.

12. The computer system of claim 11, wherein the control request information comprises an address resolution protocol offload request, and wherein the address resolution protocol offload request is one address resolution protocol offload request selected from a plurality of address resolution protocol offload requests including an enable offload request to enable address resolution protocol offload processing, a set request to register an address for address resolution protocol offload processing, and an add cache request to request address resolution protocol processing for an address.

13. The computer system of claim 11, wherein the control request information includes an address resolution protocol filter request to be used to filter address resolution protocol requests.

14. The computer system of claim 11, wherein the transmitting the control request information includes updating a control block to indicate the location in which the control request information is stored.

15. The computer system of claim 11, wherein the receiving the indication of the another location storing the control reply information includes accessing a control block of the control plane receive queue to obtain the another location.

16. A computer program product comprising:
a set of one or more computer-readable storage media; and
program instructions, collectively stored in the set of one or more computer-readable storage media, for causing at least one computing device to perform computer operations including:
transmitting, by a control program executing on a computing device of a computing environment to an adapter module executing within the computing environment, control request information, the transmitting using a control plane transmit queue of a set of queues, the control plane transmit queue identifying a location to store the control request information to be retrieved by the adapter module;
receiving, by the control program from the adapter module, an indication of another location storing control reply information replying to the control request information, the indication obtained from a control plane receive queue of the set of queues;
retrieving, by the control program from the another location, the control reply information; and
performing processing, by the control program, based on the control reply information.

17. The computer program product of claim 16, wherein the control request information comprises an address resolution protocol request.

18. The computer program product of claim 16, wherein the control request information comprises an address resolution protocol offload request, and wherein the address resolution protocol offload request is one address resolution protocol offload request selected from a plurality of address resolution protocol offload requests including an enable offload request to enable address resolution protocol offload processing, a set request to register an address for address resolution protocol offload processing, and an add cache request to request address resolution protocol processing for an address.

19. The computer program product of claim 16, wherein the control request information includes an address resolution protocol filter request to be used to filter address resolution protocol requests.

20. The computer program product of claim 16, wherein the transmitting the control request information includes updating a control block to indicate the location in which the control request information is stored.

21. The computer program product of claim 16, wherein the receiving the indication of the another location storing the control reply information includes accessing a control block of the control plane receive queue to obtain the another location.

22. A computer-implemented method comprising:
obtaining, by an adapter module executing within a computing environment from a control program executing on a computing device of the computing environment, an add address resolution protocol cache request for a selected address;
sending an address resolution protocol request to the selected address;
receiving a reply to the address resolution protocol request; and
sending the reply to the control program.

23. The computer-implemented method of claim 22, wherein the reply includes another address corresponding to the selected address.

24. A computer program product comprising:
a set of one or more computer-readable storage media; and
program instructions, collectively stored in the set of one or more computer-readable storage media, for causing at least one computing device to perform computer operations including:
obtaining, by an adapter module executing within a computing environment from a control program executing on a computing device of the computing environment, an add address resolution protocol cache request for a selected address;
sending an address resolution protocol request to the selected address;
receiving a reply to the address resolution protocol request; and
sending the reply to the control program.

25. The computer program product of claim 24, wherein the reply includes another address corresponding t the selected address.
